(19) United States
(12) Patent Application Publication
(10) Pub. No.: US 2016/0340217 A1
(43) Pub. Date: Nov. 24, 2016

(54) WATER TREATMENT SYSTEM

(71) Applicant: Access Business Group International LLC, Ada, MI (US)

(72) Inventors: Roy W. Kuennen, Caledonia, MI (US); Richard J. Weber, Grand Haven, MI (US); Terry L. Lautzenheiser, Nunica, MI (US); Ryan D. Schamper, Grand Haven, MI (US); Zhenxiao Cai, Kentwood, MI (US); Kenny Ly, Zeeland, MI (US)

(21) Appl. No.: 15/159,852

(22) Filed: May 20, 2016

Related U.S. Application Data
(60) Provisional application No. 62/306,256, filed on Mar. 10, 2016.
(60) Provisional application No. 62/164,919, filed on May 21, 2015.

(51) Int. Cl. C02F 9/00; C02F 1/28; C02F 1/76; C02F 1/52; C02F 3/00

(52) U.S. Cl. CPC C02F 9/00; C02F 1/52; C02F 3/00; C02F 1/76; C02F 1/283; C02F 2201/008; C02F 2203/008

(57) ABSTRACT

A portable water treatment system selectively configurable between a portable configuration and a water treatment system configuration. The portable water treatment system includes multiple nest and stack containers. A flocculation container includes a manual valve component that interacts with a filter support to form a valve that controls flow of water. The filter system may include one or more rotatable biofoam filters, each with a restriction orifice to control flow rate and allow a biological community to colonize and develop on or in the filters. The filters can be rotated between a filter operating position and a filter maintenance position. The water treatment system may include a chlorination system that can handle a chlorine tablet that does not contain a stabilizer. The water treatment system may include a storage container with a carbon filter that removes chlorine from the water before being dispensed. The carbon filter can be retained in place using a retaining frame with a U-shaped opening for clamping the end cap of the carbon filter.

### CROSS-REFERENCE TO RELATED APPLICATIONS

U.S. Patent publication 2011/0303589 to Kuennen et al. filed on Jan. 12, 2010, entitled “Gravity Feed Water Treatment System” is hereby incorporated by reference in its entirety. U.S. Patent Publication 2012/0145618 to Kuennen et al. filed on Dec. 10, 2010, entitled “Gravity Feed Water Treatment System with Oxidation and Disinfection Steps” is hereby incorporated by reference in its entirety. U.S. Patent Publication 2012/0132575 to Kuennen et al. filed on Nov. 29, 2011, entitled “Foam Water Treatment System” is hereby incorporated in its entirety.

### BACKGROUND OF THE INVENTION

The present disclosure relates to water treatment systems.

As the world's population increases, the demand for water also increases. Indeed, in some parts of the world where the local population is growing at a much higher rate than average, the availability of safe drinking water is lower than average. Some of this situation can be attributed to geography, whether from an arid climate or simply the lack of fresh surface water suitable for drinking. Additionally, many wellheads are running dry due to the lowering of underground aquifers, resulting in new wells being drilled to deeper depths, in an attempt to find water. In many cases, high costs prohibit these operations. Further, in many locales where water is very scarce, the population is unable to purchase water for consumption due to their low income levels and the fact that municipally treated water is unavailable. Examples of such settings may include rural villages in under-developed countries, emergency relief sites following natural disasters, or camp settings, to name a few.

Gravity feed water treatment systems are used globally to help low income populations provide safe water for their families for drinking and cooking. One known gravity feed water treatment system uses a bio-sand water filter to treat water. These systems have a biological layer that is formed from natural processes that destroys unwanted microorganisms and organics in water. The bio-sand filters commonly used in residential and small village settings tend to be large and heavy. Some contain as much as 100 pounds of sand and gravel.

Some advancement in bio-sand filtration has been made over the years. For example, some bio-sand filters have adjusted the depth and particle size composition in order to control the face velocity at the top of the exposed sand layer. In effect, one of the reasons for the large mass of sand and gravel in the deeper layers is to establish and control back-pressure so that the face velocity through the sand bed is kept within the recommended range. Although these advancements have made the gravity feed systems more effective in some circumstances, installation can be more complicated because often times the flow rate must be adjusted during installation to ensure that the system is working properly.

Some believe that the two main disadvantages of bio-sand water treatment systems are the weight of the sand and specific particle size needed for the sand. The manufacturing and transportation of the sand has been a major obstacle in the global implementation of bio-sand filters. There are water treatment systems that utilize concrete, foam, and plastic alternatives.

There are a number of other issues with conventional gravity feed water treatment systems. For example, there can be issues with timing the release of water from the flocculation stage, maintaining filters, and consistently and efficiently chlorinating, just to name a few. Further, additional improvements to portability, efficiency, and cost are welcome.

### SUMMARY OF THE DISCLOSURE

One aspect of the present invention provides a portable water treatment system selectively configurable between a portable configuration and a water treatment system configuration. The portable water treatment system may include multiple nest and stack containers.

In another aspect, flocculation occurs in a flocculation container using one or more flocculation agents. The water may be released to another container using a manual valve assembly. The flocculation container includes an inlet for receiving water and an outlet for dispensing water. A filter support includes a flow restriction aperture for restricting flow of water through said outlet and is capable of supporting a filter that covers said flow restriction aperture. A manual valve component cooperates with the filter support to form a valve that controls flow of water. The valve component includes a valve component aperture and the valve component is manually movable between an open valve position and a closed valve position. The flow restriction aperture and the valve component aperture are aligned in the open valve position to create a water flow path through the valve component aperture to the outlet. The flow restriction aperture and the valve component aperture are misaligned in the closed valve position to hinder a water flow path through the valve component aperture to the outlet.

In another aspect, a method for accelerating flocculation can be provided. The method can include adding a first flocculant to a flocculation chamber having water, mixing the first flocculant and water in the flocculation chamber, and waiting a pre-determined delay period for flocs to begin to form. Then, a second flocculant can be added to the water after the pre-determined delay period to accelerate floc formation. That second flocculant is mixed in the water with the first flocculant in the flocculation chamber. Then, the method includes waiting for the flocs to fully form and settle to the bottom of the flocculation chamber. In one embodiment, the mixing steps are performed for about one minute and the delay period between adding the flocculants to the water is between about two minutes and ten minutes. As a result of this process, the time spent waiting for flocs to sufficiently settle to the bottom of the flocculation chamber is between ten minutes and two hours, which is a significant reduction over conventional flocculation processes.

In another aspect, the filter container may include a filter system with one or more biofoam filters, each with a restriction orifice to control flow rate and allow a biological community to colonize and develop on or in the filters. The filter system can include a filter support assembly with one or more rotatable filter support arms that can be rotated between a filter operating position and a filter maintenance position. Rotating the filter support arm to the filter operation position creates a water communication between the filter container and the outlet of the filter container. Rotating the filter support arm to the filter maintenance position prevents water communication between the filter container and the filter container outlet. This prevents unfiltered water in the reservoir of the filter container from entering the clean water stream and causing recontamination. In some embodiments, the filter container can have a minimum water level for operation. In those embodiments, the filter operation position can be configured such that a filter support inlet is below the minimum water level, and the filter maintenance position can be configured such that the filter support inlet is above the minimum water level.

In another aspect, water is chlorinated via a chlorination system. The chlorination system may be configured to handle a chlorine tablet, such as calcium hypochlorite that does not contain a stabilizer. The chlorination system may include a cone shaped tip positioned in the water flow path for controlling the water flow path. The chlorination system includes a capsule for shielding a chlorine tablet from the water flow path. The capsule includes one or more horizontal slots located along a side wall of the capsule enabling water communication with a chlorine tablet positioned within the capsule.

In yet another aspect, a storage container may be used to store chlorinated water and to prevent recontamination of treated water. The storage container may include a carbon filter that removes chlorine from the water before being dispensed. The carbon filter can be retained in place using a retaining frame with a U-shaped opening for clamping the end cap of the carbon filter.

### BRIEF DESCRIPTION OF THE DRAWINGS

The disclosure may be better understood with reference to the drawings and following description. Non-limiting and non-exhaustive embodiments are described with reference to the following drawings. The components in the drawings are not necessarily to scale, with the emphasis instead being placed upon illustrating the principles of the invention. In the drawings, like-referenced numerals designate corresponding or similar parts throughout the different views.

FIGS. 1A-C illustrate a perspective view and two side views of one embodiment of nest and stack containers configured in a water treatment system configuration;

FIG. 2 illustrates a perspective view of nest and stack containers configured in a transportation configuration;

FIG. 3A illustrates a perspective view of a flocculation container with the lid open;

FIG. 3B illustrates an exploded view of a manual valve assembly;

FIG. 4A illustrates a perspective view of the flocculation container with sectional lines;

FIG. 4B illustrates a sectional view along sectional line 4B;

FIG. 5A illustrates a sectional view along sectional line 5A with the manual valve component in an open position;

FIG. 5B illustrates a sectional view along sectional line 5A with the manual valve component in a closed position;

FIG. 6A illustrates a perspective view of a filter container;

FIG. 6B illustrates a top view of the filter container with the lid removed and a sectional line;

FIG. 6C illustrates a perspective view of the filter container with a snap-on lid;

FIG. 6D-6E illustrates two side views of the filter container;

FIG. 7 illustrates an exploded view of a filter assembly;

FIG. 8 illustrates a sectional view of the filter container along sectional line 8 with the filter assembly in a filter operation position;

FIG. 9 illustrates a sectional view of the filter container along sectional line 8 with the filter assembly in a filter maintenance position;

FIG. 10 illustrates an exploded view of a chlorination system;

FIG. 11A illustrates a perspective view of a storage container with a portion of a chlorination system and a spigot connected to the outlet;

FIG. 11B illustrates a top view of the storage container;

FIG. 11C illustrates a side view of the storage container with a sectional line;

FIG. 11D illustrates a side view of the storage container;

FIG. 12A illustrates a sectional view along sectional line 12A of the storage container;

FIG. 12B illustrates a sectional view along sectional line 12B of the storage container;

FIG. 13 illustrates an exploded view of the storage container;

FIG. 14 illustrates a perspective view of the storage container with water treatment system and dispense components removed;

FIG. 15 illustrates a perspective view of the filter container with the chlorination system removed;

FIG. 16 illustrates an exploded view of a carbon filter assembly and manual pump; and

FIG. 17 illustrates an alternative embodiment of a manual pump.

FIG. 18 illustrates a perspective view of an embodiment of a two container water treatment system.

FIG. 19 illustrates an exploded view of a two container water treatment system with a manual ball valve assembly.

FIG. 20 illustrates a side view of one embodiment of a manual ball valve assembly.

FIG. 21 illustrates a top view of the manual ball valve assembly.

FIGS. 22 and 23 illustrate sectional views of the manual ball valve assembly.

FIGS. 24 and 25 illustrate exploded views of the manual ball valve assembly.

FIG. 26 illustrates an exploded view of a two container water treatment system with a manual EPDM valve assembly.

FIG. 27 illustrates a perspective view of one embodiment of a manual EPDM valve assembly.

FIG. 28 illustrates a top view of the manual EPDM valve assembly in a closed position.

FIGS. 29-30 illustrate sectional views of the manual EPDM valve assembly in a closed position.

FIG. 31 illustrates a top view of the manual EPDM valve assembly in an open position.

FIGS. 32-33 illustrate sectional views of the manual EPDM valve assembly in an open position.

FIG. 34 illustrates an exploded view of the manual EPDM valve assembly.

FIG. 35 illustrates a sectional view of an alternative embodiment of a replacement filter.

### DETAILED DESCRIPTION OF THE DISCLOSURE

The water treatment system 1 of the present disclosure is configurable for a variety of situations. The various components can be used singularly or in various combinations to treat water for consumption or other uses. The configurations detailed below are exemplary and not exhaustive.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The present invention can be implemented with multiple nest and stack containers. Each nest and stack container may be capable of nesting with the other containers in a compact group that takes up relatively little space. Further, the nest and stack containers may be capable of stacking one on top of another. The nest and stack containers can be selectively configured between a compact storage and transportation configuration and a water treatment system configuration. In the transportation configuration, each of the containers nest within one another and water treatment system components can be stored within one or more of the nested containers. When the system is deployed to the water treatment system configuration, each of the containers can have a lid and each of the containers can be stacked on top of one another with the various water treatment system components mounted to the containers at appropriate positions as discussed in more detail below.

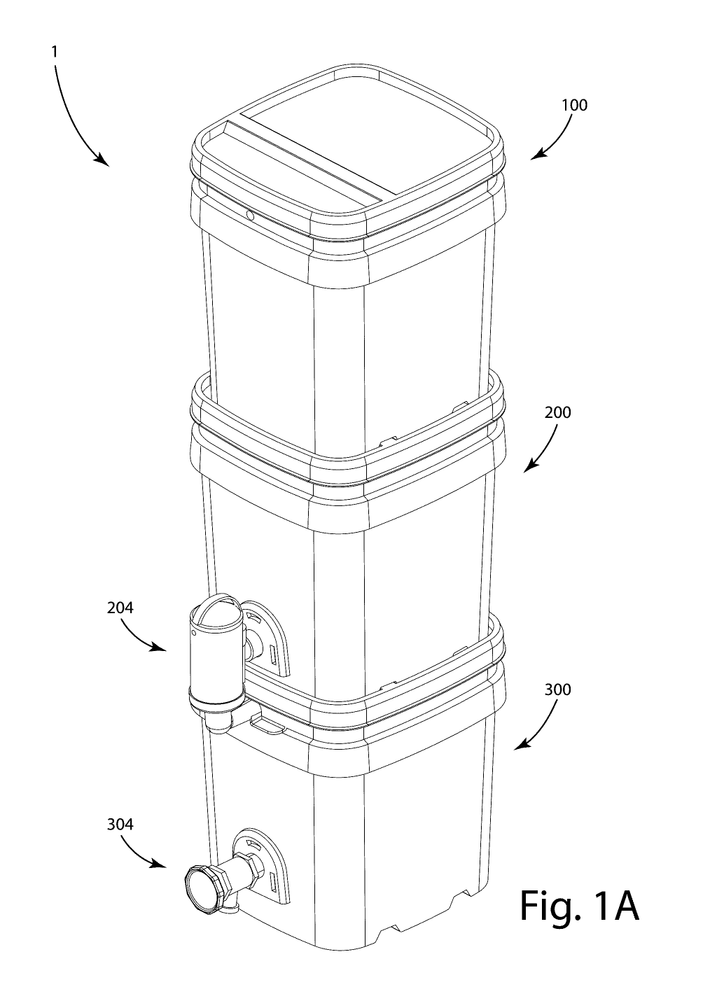

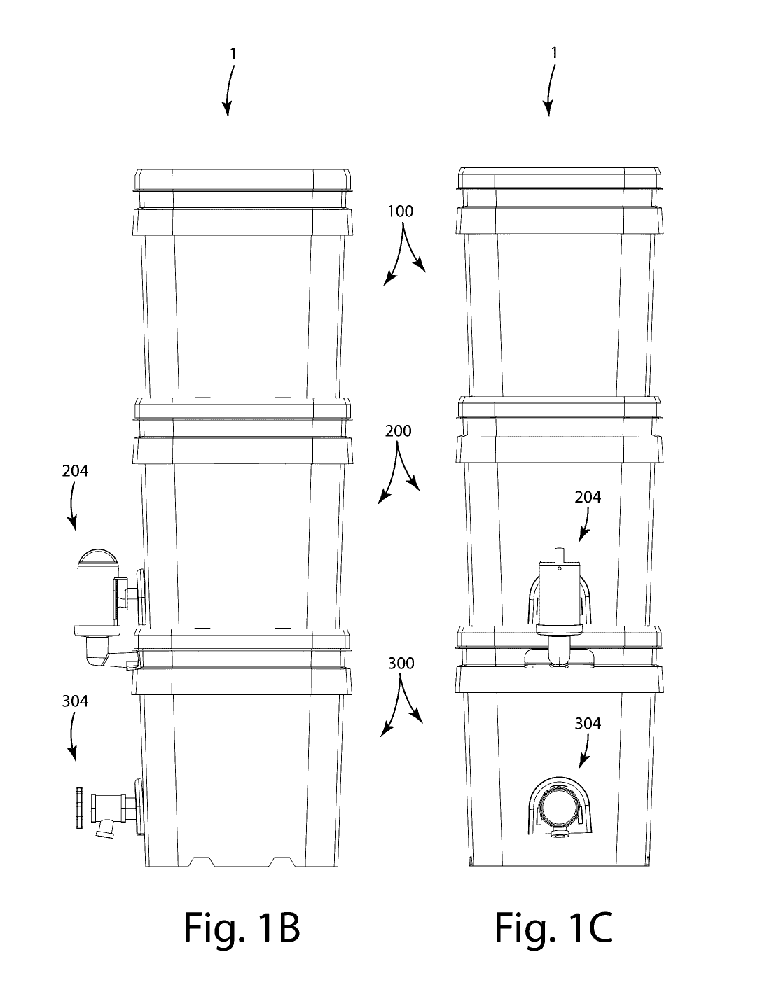

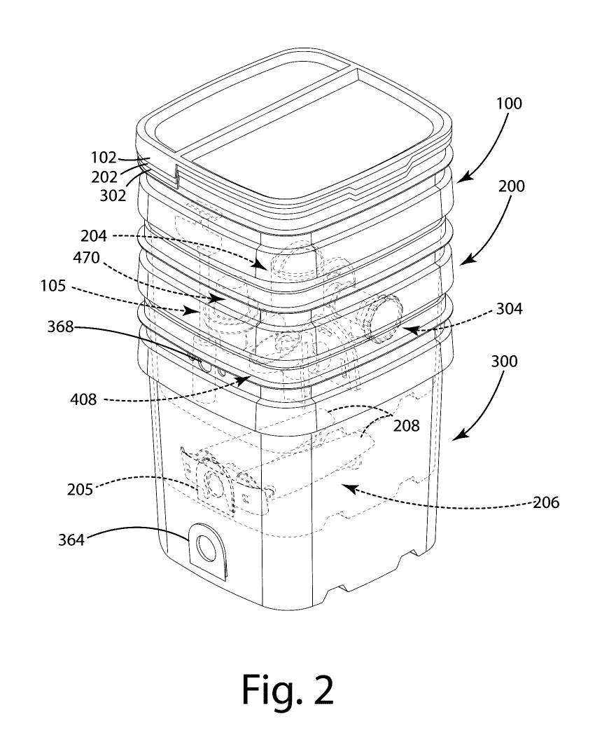

FIGS. 1A-C illustrate one embodiment of a water treatment system 1 with three nest and stack containers 100, 200, 300. The water treatment system 1 can be selectively configured between a transportation configuration (FIG. 2) and a water treatment system configuration (FIGS. 1A-C). The depicted embodiment includes a flocculation container 100, a filter container 200, a chlorinator system 204, a storage container 300, and a spigot 304. The depicted water treatment system 1 has four stages: a flocculation stage, a bio-filtration stage, a chlorination stage, and a carbon filter stage. Alternative constructions may include additional or fewer nest and stack containers and may include additional, fewer, or different water treatment system stages.

Each of the nest and stack containers may have an associated lid. In the depicted embodiment each container has an associated lid 102, 202, 302. The lids may be snap-fit, and may include a retaining feature 107, 207, 307 that interacts with a retaining feature 119, 219, 319 on the bottom surface of a container. In this way, with the lids in place, the containers can be stacked into a water treatment system configuration. A section of the lid of each bucket may optionally be hinged to allow easy access to the interior of the bucket during initialization or maintenance procedures. Alternatively, a water inlet pipe may be located at or near to the top of the bucket to accept water from a hose, pipe or any other method of feeding water into the system. The bucket is optionally supplied with a carrying handle for ease of transportation and maintenance.

Various water treatment system components can be removably mounted to the nest and stack containers in order to configure the system into the water treatment system configuration. For example, a chlorination system 204 can be mounted to the outlet of a container and provide a water flow path to another container. The water treatment system components can be stored in one or more of the nest and stack containers while configured in the transportation configuration.

FIG. 2 illustrates the water treatment system 1 with three nest and stack containers 100, 200, 300 in a transportation configuration. In this embodiment, the containers are shown nested inside of each other. Various water treatment system components can be stored inside the containers. For example, the chlorination system 204, spigot 304, and other various components that are deployed inside of the containers can be removed from their normal positions and put into storage locations in the transportation configuration. By removing the water treatment system components from their mounted positions on the nest and stack containers, the containers can nest inside of one another. Other water treatment system components can remain in place without interfering with nesting, when the containers are nested. For example, the manual valve component 105 and filter system 206 can be left in place in their respective containers.

The size of the containers can vary without departing from the scope of the disclosure. For example, small containers around 5 gallons each could be used for treating water, or larger containers of 50, 500, or 1000 gallons or more could also be used. The processes disclosed herein are still applicable for various sizes depending upon the volume of water to be treated.

In the illustrated embodiment, flocculation can occur in a flocculation container 100 using one or more flocculants. Untreated water can be mixed with the flocculant(s) and allowed to settle for a period of time. One embodiment of a flocculation process that will be described in more detail below can be utilized to accelerate the process. Once flocculation is complete, a manual valve assembly may be used to release the water to a filter container 200 for a bio-filtration water treatment stage. Before flowing into the filter container 200, water can flow through a coarse filter to prevent large coagulated particles (sometimes referred to as flocs) from leaving the flocculation container 100. The flow rate of the water leaving the flocculation container can be restricted. For example, the flocculation container may include a restriction orifice in the water flow path that prevents the water exiting the flocculation container from flowing too fast and agitating settled flocs. It can also be useful to restrict the flow rate of water exiting the flocculation container for downstream treatment systems.

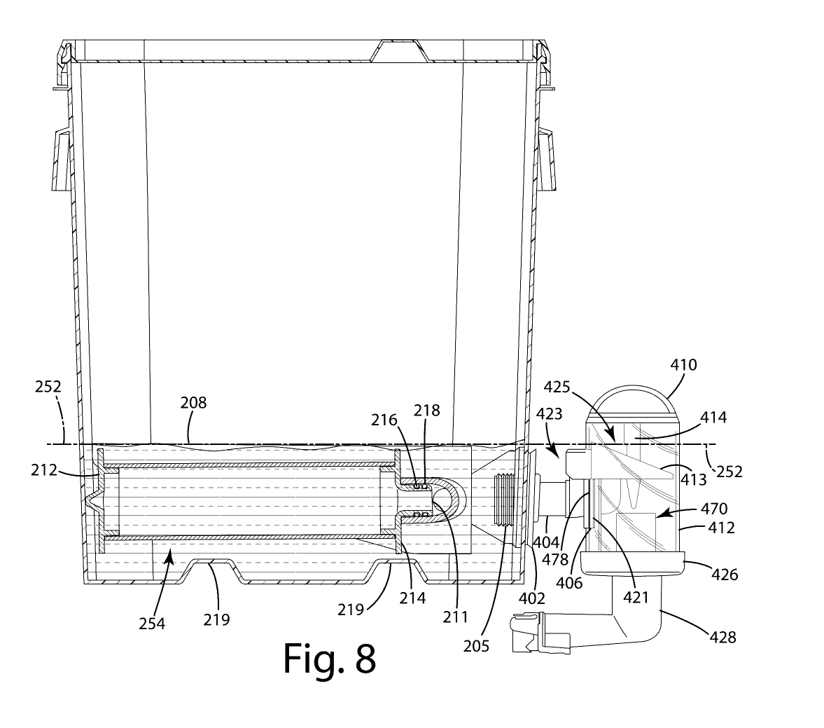

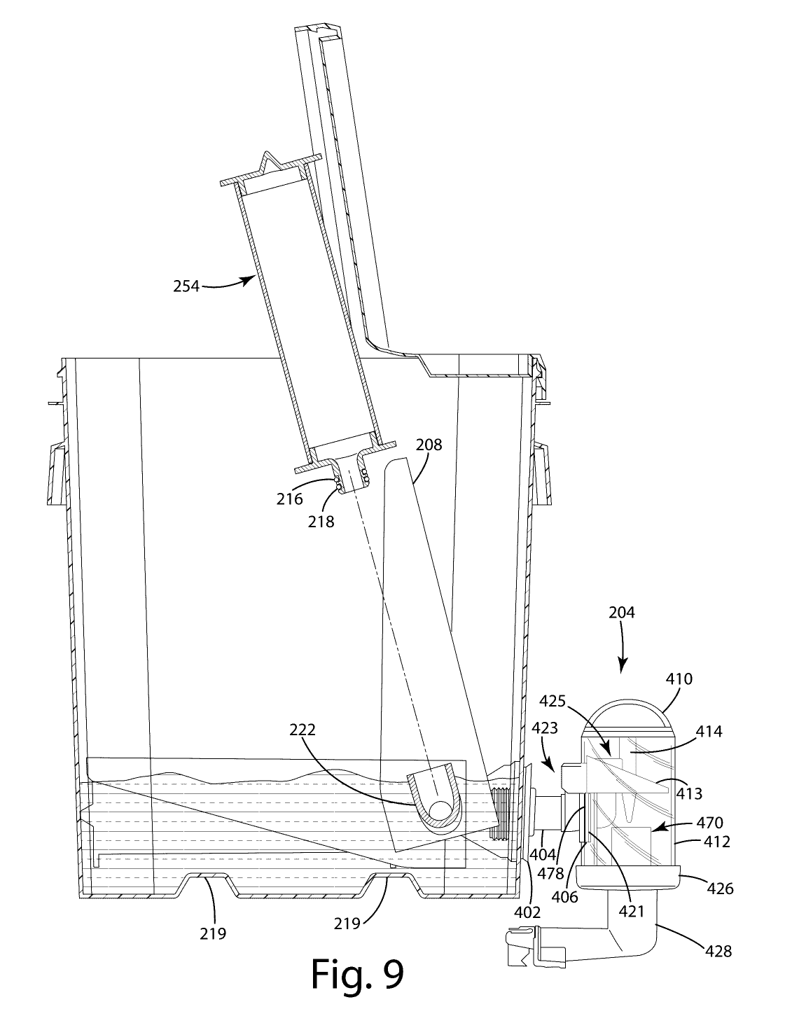

The filter container 200 may include a filter system with one or more biofoam filters, each with a restriction orifice to control flow rate and allow a biological community to colonize and develop on or in the filters. The biological layer removes pathogenic organisms, like cyst, bacterial and virus from the water. The filter system can include a filter support assembly with one or more rotatable filter support arms 222 that can be rotated between a filter operating position (see FIG. 8) and a filter maintenance position (see FIG. 9). The filter support arm 222 also acts as a filter support inlet for receiving water from a filter element 254. The filter support arms 222 can be independently rotated with respect to manifold 225, allowing the filter elements (including shields) to be independently rotated. Rotating the filter support arm 222 to the filter operation position creates water communication between the filter container and the outlet of the filter container. Rotating the filter support arm 222 to the filter maintenance position prevents water communication between the filter container and the filter container outlet. This prevents unfiltered water in the reservoir of the filter container from entering the clean water stream and causing recontamination. In some embodiments, the filter container can have a minimum water level 252 for operation. In those embodiments, the filter operation position can be configured such that a filter support inlet 222 is below the minimum water level, and the filter maintenance position can be configured such that the filter support inlet 222 is above the minimum water level. It is worth noting that the water level 252 may lower as the filter element 254 and shield 208 are rotated out of the water. The filter support inlet 222 can be positioned such that when rotated, the inlet 222 is above the water level as shown in FIG. 9, which is a lower water level than the water level shown in FIG. 8 when the filter elements and shields are submerged.

Water leaving the filter container 200 is chlorinated via chlorination system 204 before entering the storage container 300. The chlorine tablet used in the illustrated embodiment can be a calcium hypochlorite chlorine tablet, which does not contain a stabilizer present in some other chlorine tablets, such as trichloroisocyanuric acid, or another tablet. The chlorination system releases a pre-selected amount of chlorine to dose the water until the tablet is consumed.

The storage container 300 includes a carbon filter that removes chlorine from the water before being dispensed. The carbon filter can be retained in place using a retaining frame. Water may flow through the system using gravity alone. Alternatively, a manual pump can be used to increase flow rate through the carbon filter and the outlet in the storage container 300.

I. Flocculation Stage

According to one embodiment, the gravity feed water treatment system can remove contaminants from water by flocculation. Flocculation involves using a chemical agent of some sort (a flocculant) to encourage particles suspended in water to come out of the solution by joining together (coagulating) and settling to the bottom of a tank or container due to their increased density caused by the addition of the flocculant. In some cases, coarse particles suspended in water will settle to the bottom of a container without addition of any flocculant, but this may take prolonged periods of time. Other particles may remain in the solution and never settle to the bottom.

In practice in rural or undeveloped areas, water is often gathered in a container or tank from a water source, such as a lake, river, or well. A flocculant can be added in small doses; for example, a teaspoon for a 5 gallon container of water to be treated. The flocculant may include a variety of chemicals, such as aluminum chlorohydrate, aluminum sulfate (alum), iron chloride, iron sulfate, polyacrylamide, poly aluminum chloride, or sodium silicate. Additional or alternative natural flocculants may also be used, such as chitosan, moringa olifera seeds, papain, or isinglass. In some embodiments a coagulant aid may be added to the container such as sodium aluminate. After the dose of flocculant is added, it may be stirred for improved results, to distribute the chemical evenly about the container. Stirring may be accomplished using a conventional electromechanical stirring device, magnetic stirring device, a mechanical stirring device such as a spoon, or other stirring methods or stirring devices.

The next step involves allowing the treated water to sit in its container for a period of time. In the case of a 5 gallon container, it may be desirable for the treated water to sit as much as 12-24 hours for the particles to coagulate and settle to the bottom of the container, although with various combinations of chemical and water conditions the time could be much shorter. As this process can be somewhat time-consuming, it may be desirable to have more than one container involved and at different stages of treatment time to produce a steady supply of flocculant-treated water. The flocculant-enriched water is then allowed to sit for a period of time, such as several hours or until the visible particulate matter has settled to the bottom of the container. It is important to note that microbes or microorganisms and some particulates and other water contaminants may remain present in the flocculant-treated water.

After the water has been cleared sufficiently, it can be removed from the container by a spigot or valve integral with the container (preferably at a point of depth above the expected sediment level).

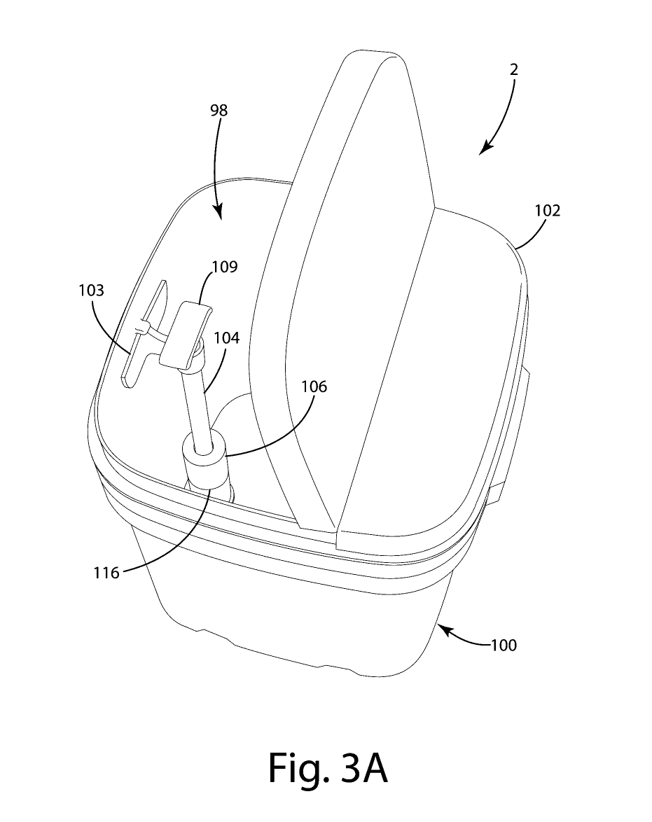

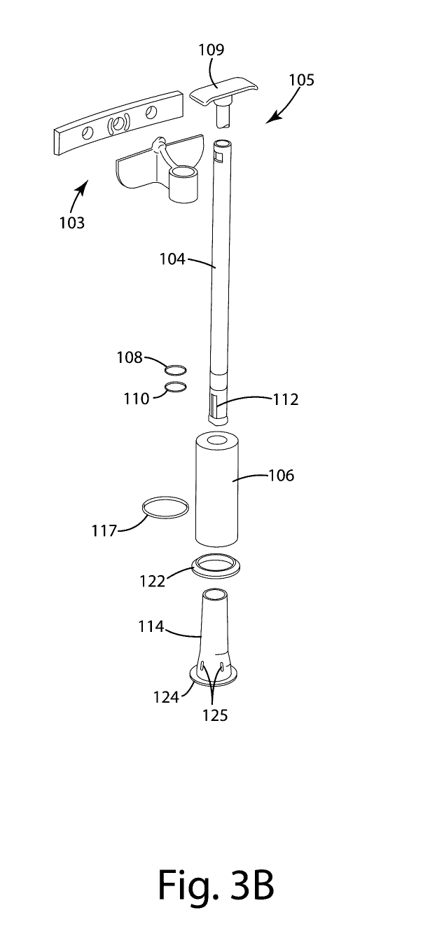

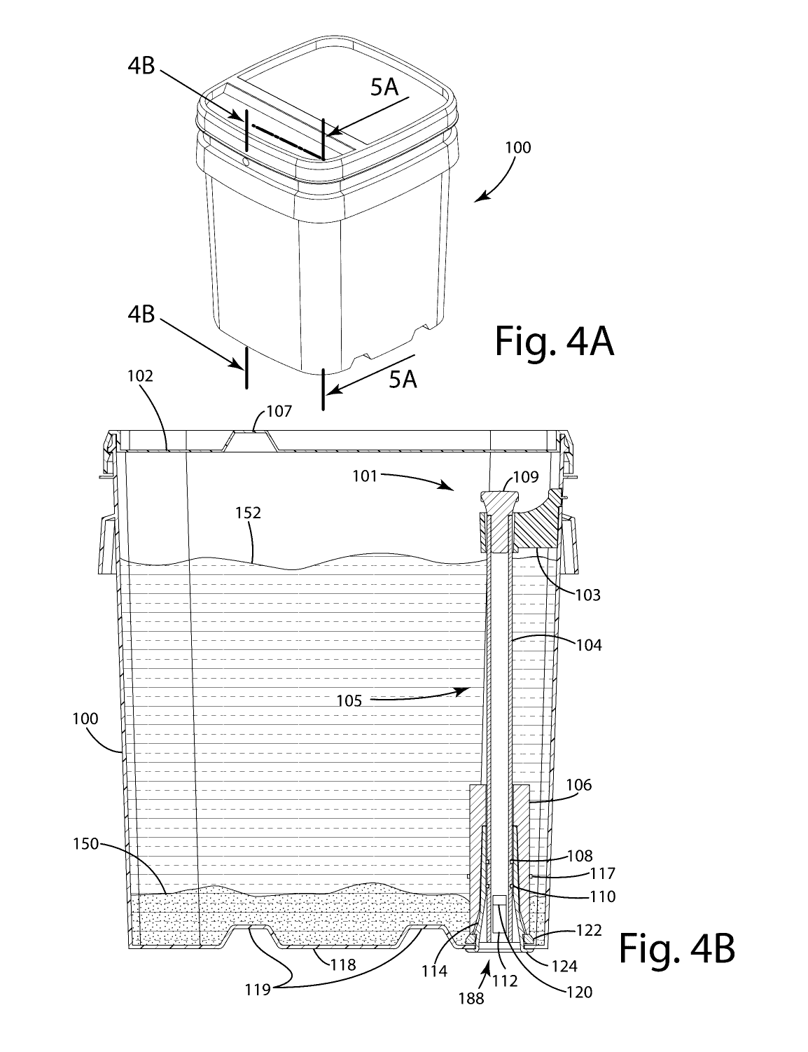

FIGS. 3A-B, 4A-B, and 5A-B illustrate a flocculation (sometimes referred to as “coagulation”) treatment system 2 according to one embodiment of the present disclosure. The system 2 generally includes a container or tank 100 having an inlet 98, an outlet 188, and a valve assembly 101. The tank 100 of the illustrated embodiment is a bucket, such as a plastic 5-gallon bucket. The bucket 100 may alternatively be essentially any other container or reservoir capable of storing the water for flocculation. In the illustrated embodiment, the outlet 188 is formed with part of the valve assembly 101 and the bottom surface 118 of the bucket. The valve assembly 101 is capable of selectively allowing water to be dispensed from the tank 100.

In the illustrated embodiment, the valve assembly 101 includes a manual valve component 105, a mounting bracket 103, a filter support assembly 114, 122, and a filter 106. The manual valve component 105 includes a movable member 104 joined with a handle 109. The manual valve component 105 of the illustrated embodiment is a hollow shaft having a window 112 near one end for allowing water flow when the manual valve component 105 is in position.

The filter support 114 is joined to the bottom surface 118 of the tank 100. In the illustrated embodiment, the filter support 114 has a tapered surface with a plurality of protrusions 125 for cooperating with a snap-fit member 122 to form a snap-joint by sandwiching the bottom surface of the tank 100 between a mounting flange 124 and the snap-fit member 122. In alternative embodiments, the filter support 114 may be secured to the flocculation container using a different attachment system and it may be secured at a different location on the flocculation container.

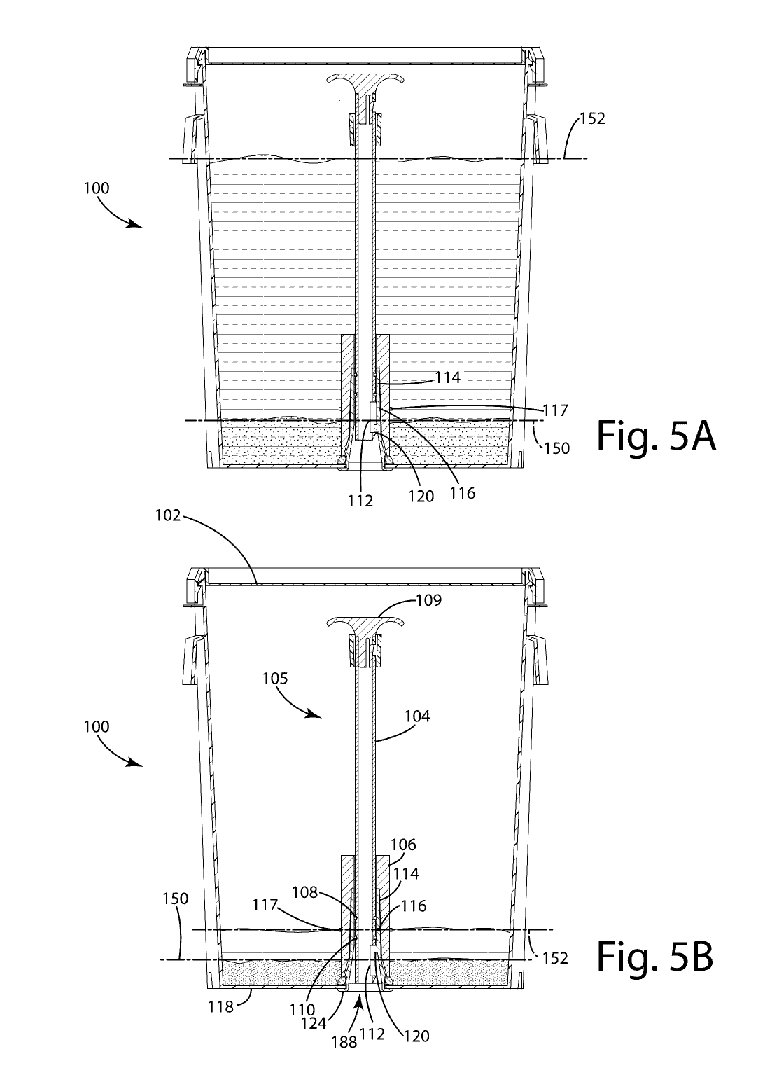

Perhaps as best shown in FIG. 5B, the filter support 114 includes a flow restrictor 116 that restricts the flow of water from the flocculation container 100 to a flow rate less than 1 liter per minute in order to avoid re-disturbing settled flocs in the example configuration. The flow restriction aperture 116 in the illustrated embodiment has a 0.161 inch diameter. The diameter of the flow restriction aperture may be manufactured larger or smaller in order to increase or decrease the flow rate of the water depending on the application. The height of the flow restriction aperture can be selected such that the sediment level 150 for an expected batch of water settles below the height of the aperture. For example, the height of the flow restriction aperture 116 may be selected based on an average case, worst case, or other case flocculation performance. That is, the anticipated maximum height of sediment 150 can be calculated based on an anticipated maximum amount of sediment in a full bucket of water with a predetermined amount of flocculant added. The height can also be influenced by the expected or desirable maintenance time schedule or number of batches preferred between cleaning cycles in which accumulated sediment can be removed.

Although the present embodiment includes a single flow restriction aperture, in alternative embodiments, multiple flow restriction apertures or other flow restrictors may be used to achieve a desired flow rate from the flocculation container 100.

The filter support is capable of supporting a filter that covers the flow restriction aperture 116. By covering the flow restriction aperture with the filter, large sediment particles can be prevented from blocking or otherwise hindering water flow through the flow restriction aperture Although the illustrated embodiment shows the filter support 114 having a generally cylindrical body portion, the filter support may have essentially any size and shape that can support the size and shape of the desired filter.

The filter support 114 cooperates with the manual valve component 105 to control the flow of water from the flocculation container. The valve component 105 is manually movable between an open valve position and a closed valve position. FIG. 5A illustrates the valve in the open position and FIG. 5B illustrates the valve in the closed position.

In the current embodiment, the valve component 105 is selectively moveable vertically between the open valve position and the closed valve position. This embodiment utilizes a manual valve component that works like a plunger in a push/pull configuration. The filter support 114 includes a protrusion or catch 120 that interacts with the top and bottom edges of the valve component aperture 112 to restrict vertical movement of the valve component 105 past the protrusion 120 in either direction. The O-rings 108, 110 may provide friction such that the valve component movement can be moved and rest in any vertical position along its travel. In this way, a user can move the manual valve component 105 to the open or closed position and leave it in place. Although the current embodiment utilizes a vertically movable valve component, other valve constructions may be used. For example, the valve component 105 may selectively be a quarter turn switch that can rotate between an open valve position and a closed valve position. In such an embodiment, the O-rings may be repositioned or eliminated. Two alternative embodiment manual valve assemblies are described in connection with the two container water treatment system embodiment described below.

The flow restriction aperture 116 and the valve component 105 aperture are misaligned in the closed valve position to hinder a water flow path through the valve component aperture of the valve component to the outlet. In this position, O-rings 108, 110 seal the space between the manual valve assembly component 105 and the filter support 114 in order to prevent water seeping therebetween. The flow restriction aperture 116 and the valve component aperture 112 are aligned in the open valve position to create a water flow path through the valve component aperture to the flocculation container outlet. In this position, O-ring 108 seals the space between the manual valve assembly component and the filter support in order to prevent water seeping upwards.

In operation, in one embodiment, flocculation can occur in the flocculation container 100 using one or more flocculants, such as aluminum sulfate (alum) and/or poly-aluminum chloride (PACl). Different flocculants can provide different results depending on a variety of factors. For example, certain flocculants may produce better results for different source water. Flocculants can be described in terms of how effectively they treat source water with certain pH ranges. The pH of source water can vary for a variety reasons, including the contamination level of the water. In general, natural water varies between a pH level of 3-11. One flocculant may be particularly effective at coagulating source water that has a first pH range and a second flocculant may be particularly effective at coagulating source water that has a second pH range. For example, PACl can have an effective pH coverage range of about between 5-9 and alum can have an effective pH coverage range of about between 6-10. These ranges can be different depending on a variety of factors.

Using two or more flocculants with different effective pH ranges can provide a wider range of pH coverage for effective flocculation. For example, by adding alum and PACl to the flocculation container, an effective pH coverage range of about between 5-10 can be provided.

The flocculation process generally includes adding water to the flocculation tank 100. After water is added into the tank 100, one or more flocculants are added to the water, and stirred for about one minute. After the water and flocculant(s) are mixed, the mixture is left alone so that flocs can form and settle to the bottom of the container. FIGS. 5A-B show the sediment level 150. In FIG. 5A, the sediment has just begun to settle. In FIG. 5B, all of the flocs have settled and the water has been dispensed to the next water treatment container. The average settling time may be from between about 10-24 hours, but may vary depending on a variety of factors.

The settling period can be defined in a variety of different ways. In some embodiments, the settling period may be defined as the amount of time for a certain percentage of flocs to settle to the bottom of the container. For example, the settling time may be the amount of time for about 90% of the flocs to settle to the bottom of the container. One way to judge whether the flocculation process is complete is to use an indicator 117. The indicator 117 can be used to indicate whether the floc has sufficiently settled and the water can be released to the next stage of treatment. The indicator 117 can be positioned about at the same height as the flow restriction orifice 116. In the current embodiment, the indicator 117 is a colored band that is hidden by floc in the water to a user viewing the flocculation container reservoir through the inlet 98 of the flocculation container. Once floc has sufficiently settled, the indicator 117 is visible to the user indicating that water can be released to the next stage. The indicator 117 can be positioned at a height above the depth of sediment 150 expected to accumulate during the settling period.

For example, FIG. 5A illustrates the container 100 is filled with water to water level 152 and the sediment has settled such that indicator 117 is visible to the user through the water. Accordingly, the manual valve component 105 can be raised to its depicted position allowing water flow through flow restriction aperture 116 and window 112 to outlet 188. Once the desired amount of water has drained out of the flocculation container, the manual valve component 105 can be moved to its closed position to stop the flow of water. For example, in FIG. 5B the water drained until the water level 152 reached the height of the flow restriction aperture 116 at which point the manual valve was closed and ready for another round of flocculation to occur. It is worth noting that the sediment settles over time during the flocculation process, which is why in FIG. 5A the sediment level 150 is shown at a higher height than the sediment level 150 in FIG. 5B. At the beginning of the flocculation process, the sediment obstructs the view of indicator 117 through the water from the top of the bucket and over time, before the sediment has fully settled, the indicator 117 becomes visible.

In one embodiment, the flocculation process can be significantly accelerated. That is, the amount of time for the indicator 117 to become visible can be significantly reduced. Specifically, by adding multiple different flocculants to the water at different times during the flocculation process, the settling time can be significantly reduced. For example, a first flocculant can be added to the water (i.e., 1.6 grams of alum powder). The water can be stirred for about one minute, or stirred until mixed for between about 15 seconds and two minutes. The water can be left still during a pre-settle period for about one minute. Then, a second flocculant can be added to the water (i.e., 0.8 grams of PACl). The water can be stirred again for about one minute, or stirred until mixed for between about 15 seconds and two minutes. Next, the mixture can be allowed to settle before being released to the next treatment stage. In one embodiment, the mixture can be allowed to settle until the indicator 117 is visible to a user looking through the water in the flocculation reservoir. By adding the flocculants at different times the settling time can be reduced from between 10 to 24 hours to between 10 minutes and 2 hours. In an alternative embodiment, the timing of the first flocculant and the second flocculant can be swapped. That is, in one embodiment, the PACl can be added at the beginning of the flocculation process, and the alum can be added after the PACl pre-settle period. Accordingly, this process can significantly reduce the flocculation settling period relative to a conventional flocculation process. Although the flocculants/coagulants used in the current embodiment are alum and PACl, these agents can be replaced with other coagulant/flocculant agents. For example, ferric chloride or another polymeric-based chemical can be used in place of the alum, the PACl, or in place of both. Further, one or more coagulants can be added to the mixture. It should be noted that the various times associated with this process may vary based on temperature. For example, the flocculation/coagulation may take longer at colder temperatures.

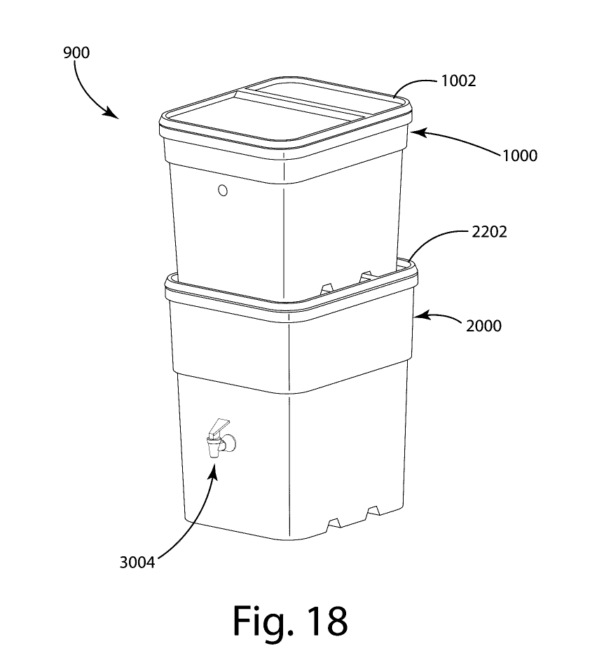

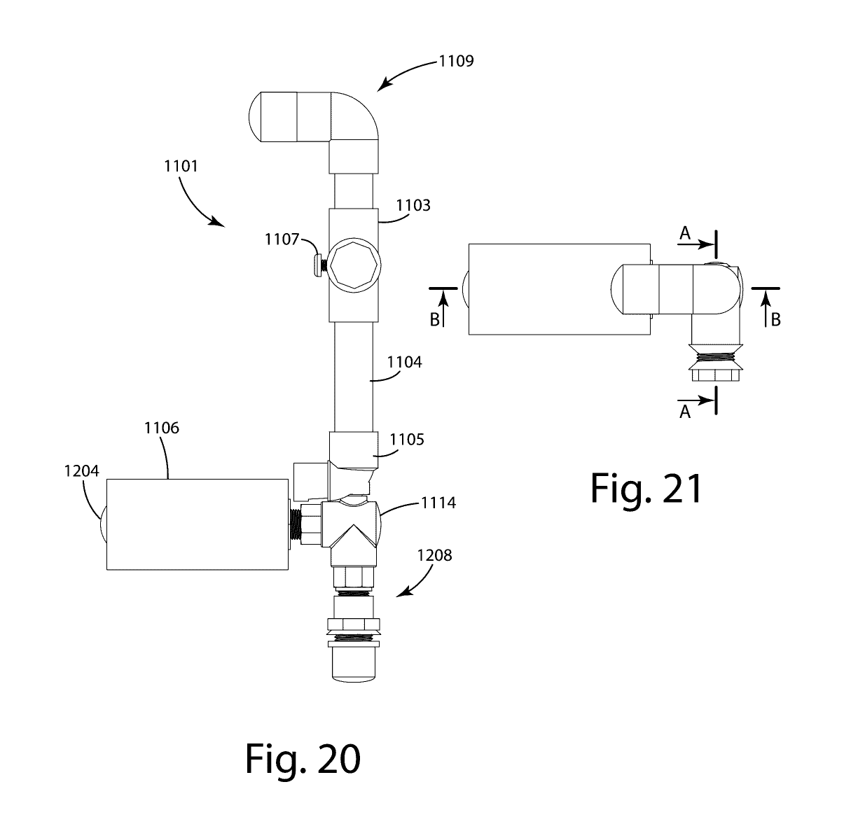

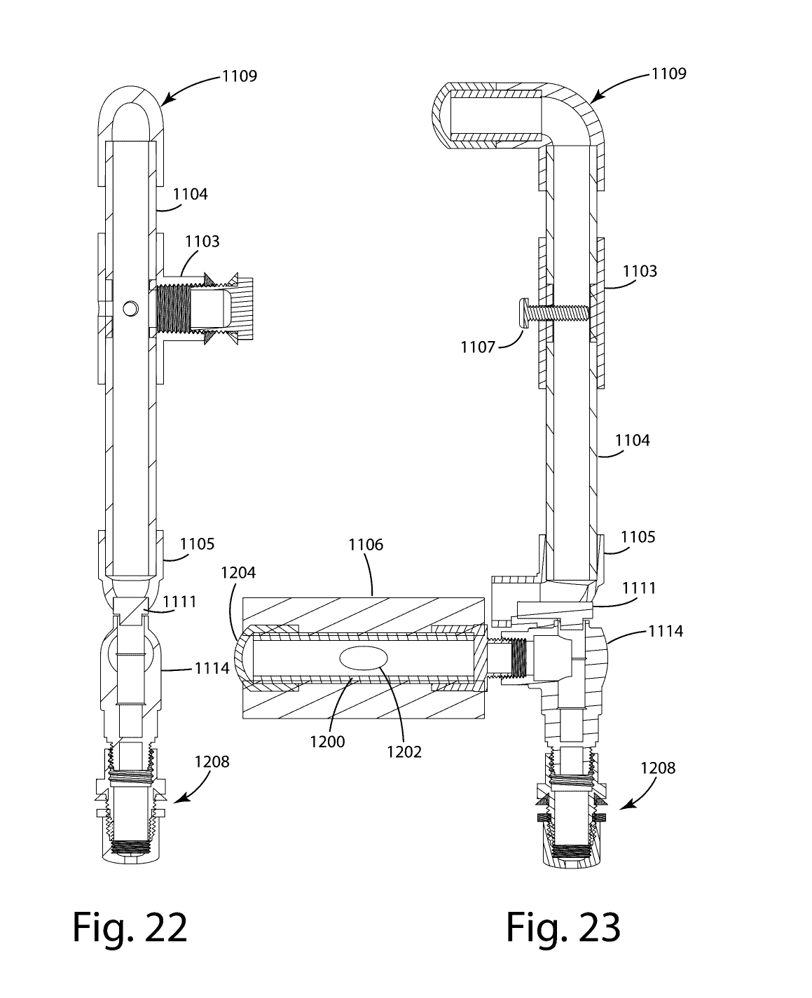

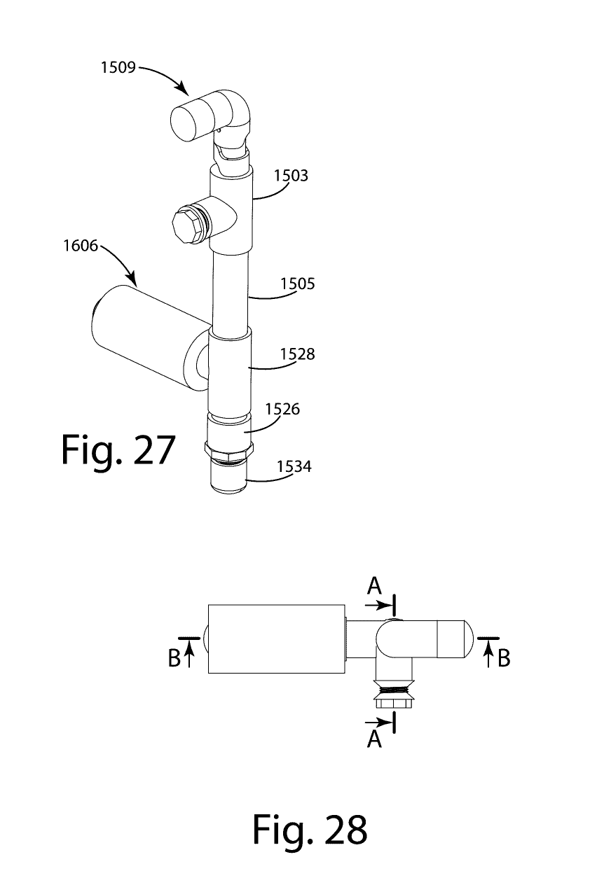

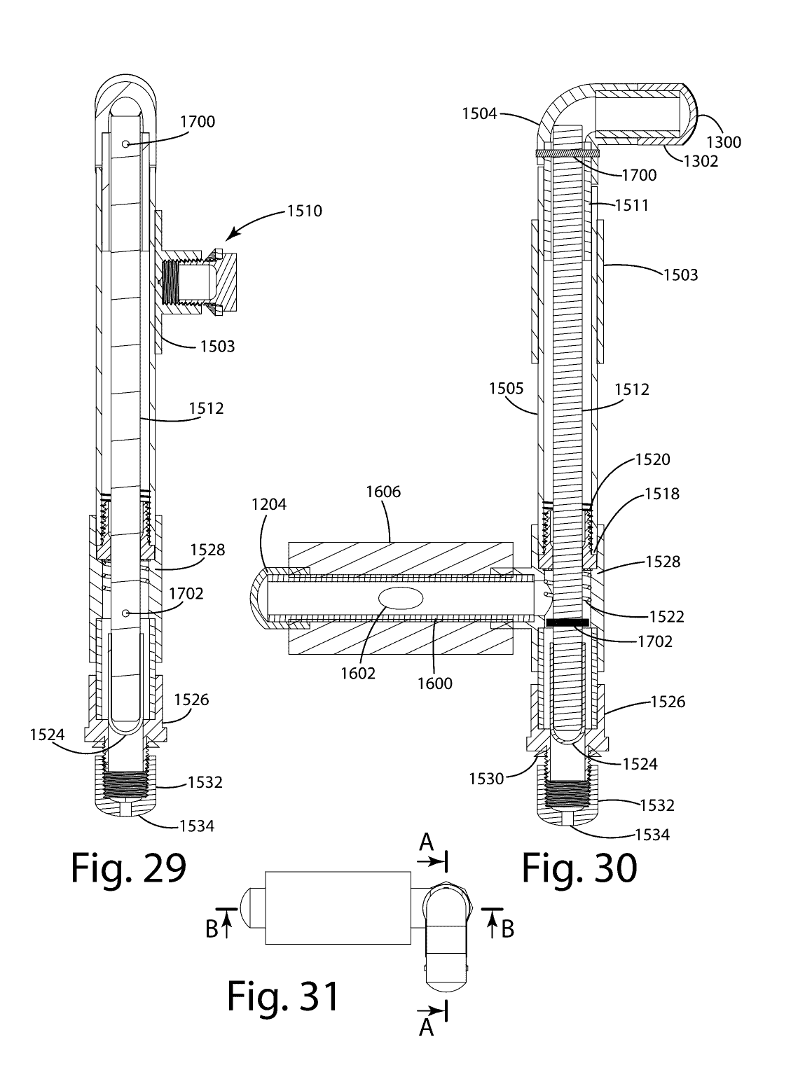

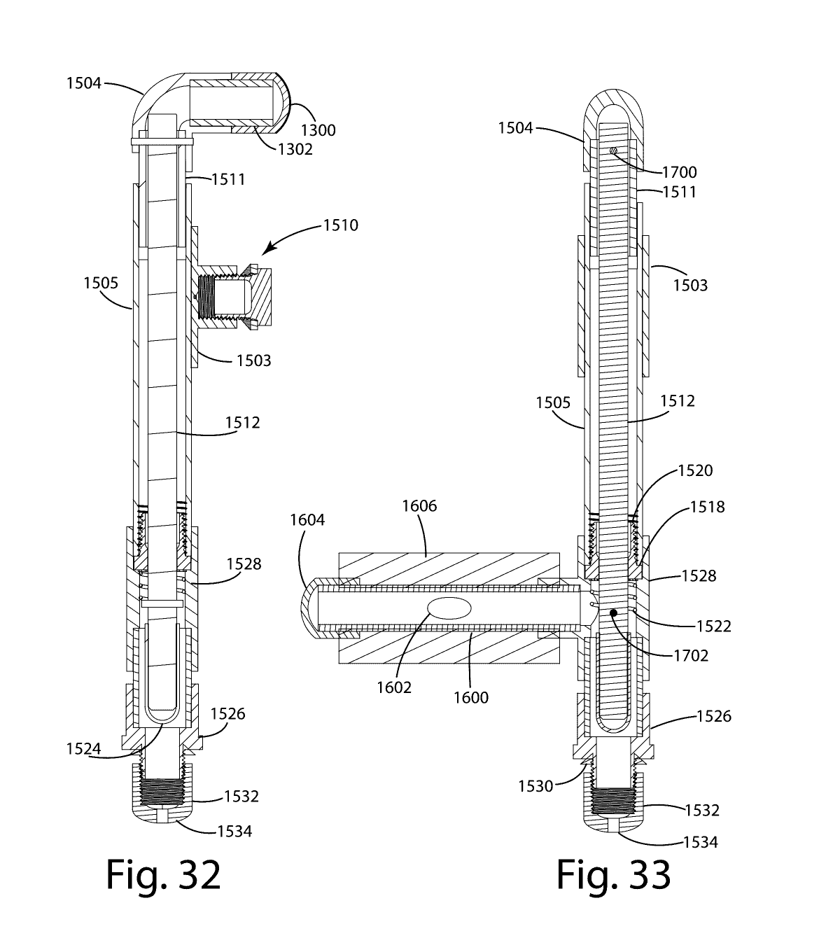

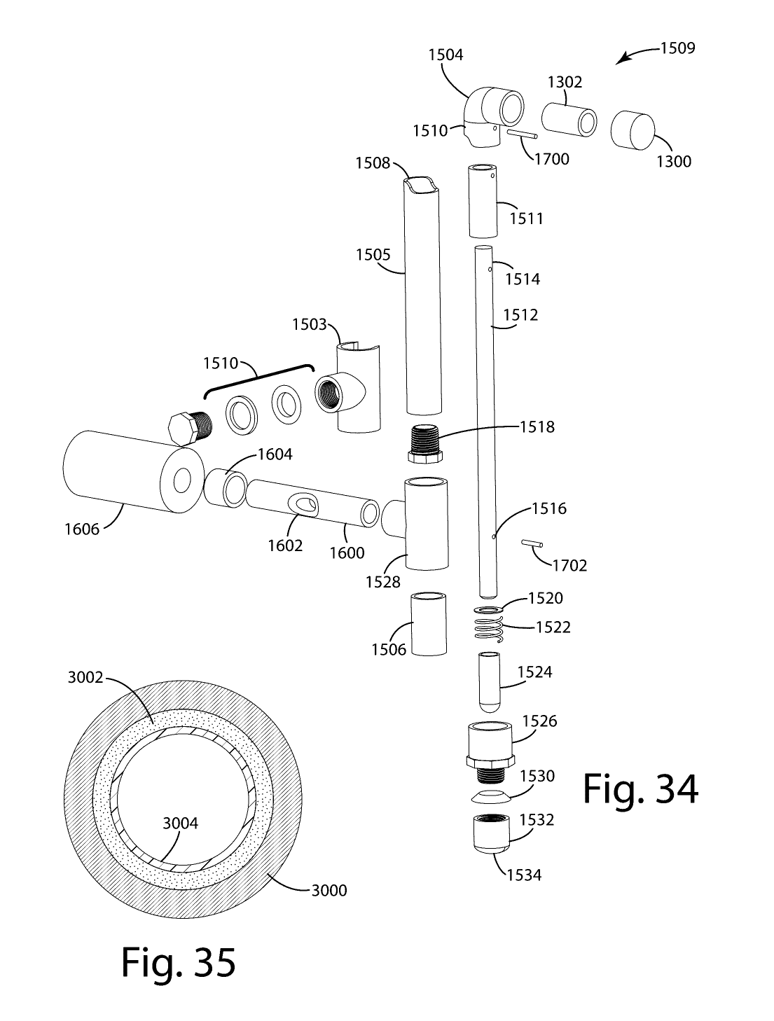

In one embodiment, tank 100 is used solely for flocculation and only one or more flocculants are added to the tank 100 with untreated water. In another embodiment, the tank (100) is used for both flocculation and chlorination. In one implementation of this embodiment, there is no biofiltration stage—tank 200 and chlorination system 204 are not used. In this embodiment, chlorine introduced into the flocculation tank 100 acts as a disinfectant and serves as an oxidant that convert As(III) to As(V). With chlorine and coagulation, the removal of Arsenic by coagulation may reach greater than 90%. Other alternative embodiments that do not include chlorination system 204 are illustrated in FIGS. 18-34 and discussed below in more detail.

The flocculation tank can be placed on top of a filter container 200 such that the outlet 188 of the flocculation container 100 is in water communication with the inlet 203 of the filter container 200. Due to the flow restriction aperture 116 and other factors, when the manual valve component is in an open position, water flow from the flocculation container 100 to the filter container 200 is regulated. In the current embodiment, the water enters the filter container 200 at a rate of about 1 L/min. In alternative embodiments, the rate can be adjusted to be faster or slower, for example by changing the size of the flow restriction aperture.

II. Filter Stage

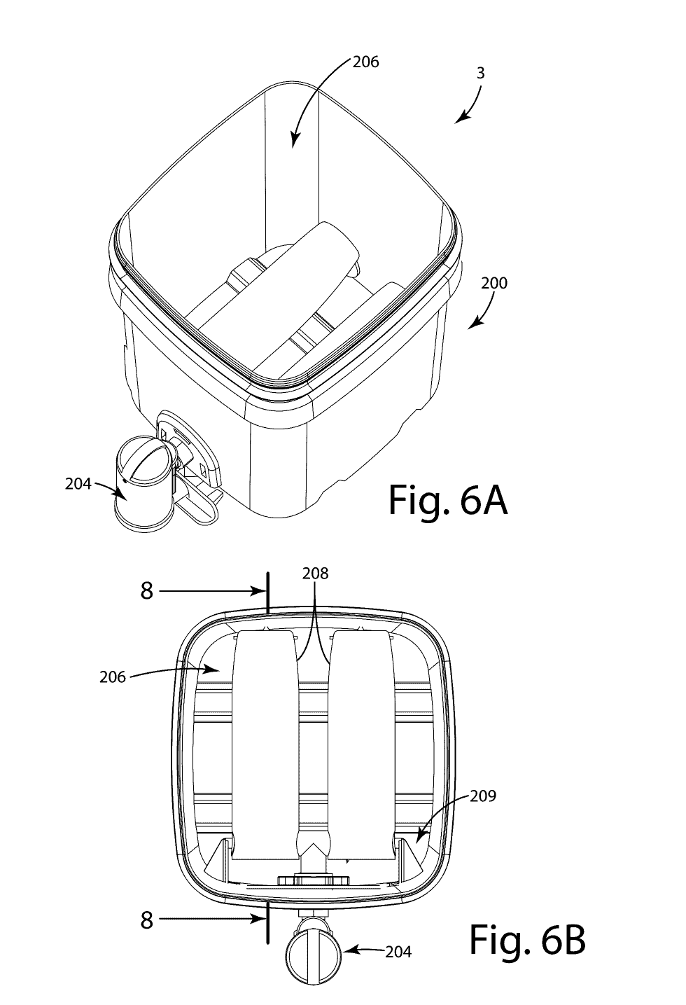

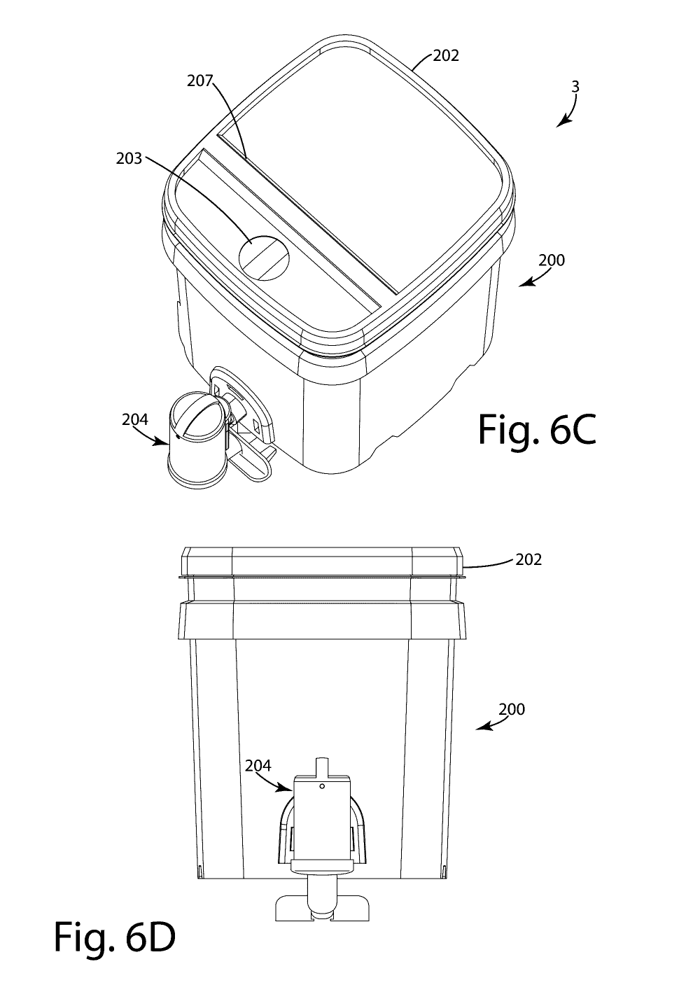

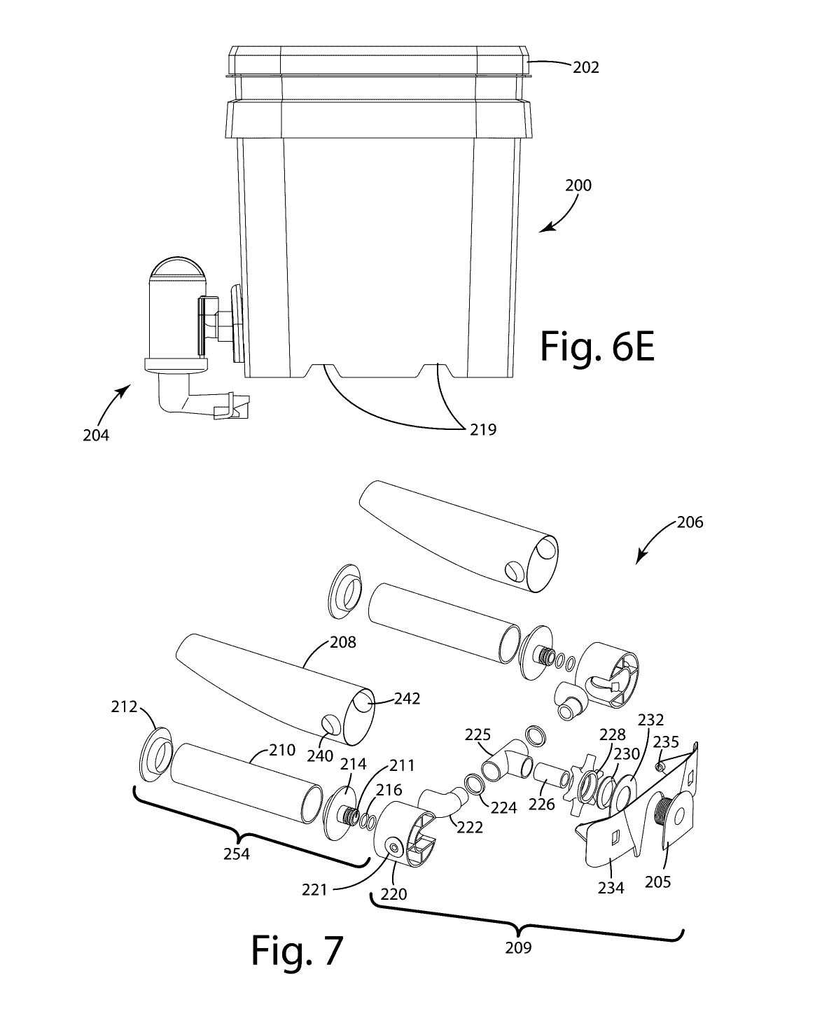

FIGS. 6A-E illustrate one embodiment of a filter system assembly 3 that can be used to implement a filter stage in a water treatment system 1. The illustrated filter system assembly 3 includes a filter container 200, a filter container lid 202, and a filter system 206 mounted within the filter container 200. The filter container lid 202 has an aperture 203 that can act as an inlet and a retaining feature 207 that can retain a nest and stack container in place on top of the filter container 200. In operation, water flows through the filter system 206 and out of the filter container 200 through an aperture in the sidewall of the filter container that acts as a filter container outlet. A chlorination system 204 is connected to the filter container outlet in the illustrated embodiment. In the illustrated embodiment, the height of the water flow path through the chlorination system 204 is higher than the filter container outlet. Accordingly, the height of the water flow path through the chlorination system 204 determines the minimum standing water level in the filter container. The chlorination system 204 will be discussed in more detail below in connection with the chlorination stage.

The filter system 206 can be a biofiltration system that reduces microbial concentrations in water flowing through a biological community developed in or on a filter element. The biofiltration system may include a restriction orifice 211 that controls the flow rate through the system and allows a biological community to colonize and develop. The biological community (sometimes referred to as a biological layer) can remove pathogenic organisms, like cyst, bacterial and virus from the water.

When water first enters the filter container 200, it fills the reservoir to a water level 252 past where the filter element in the filter system 3 is fully submerged. The biological community develops and can be maintained while fully submerged with water. The water can pass through the filter element 254 to filter particulates and microbes. The result in the water is a reduction in natural organic matter and microbes. Water flows through the filter system to the outlet of the filter container.

The relative elevations of the highest point in the water flow path and the water level in the filter container, along with any restriction orifices in the filter system, help determine how much and how fast the water flows through the filter system. The highest elevation of water in the filter container 3 helps determine the initial water pressure placed on the filter. In general, the higher the water pressure, the faster the water is able to flow through the system. The height of the filter system outlet establishes the point where water will stop flowing through the system. If the elevation of the water in the filter container drops to a level equal with or below the height of the filter system outlet, then the water pressure will equilibrate and stop flowing. In the current embodiment, the water stops flowing at a height slightly higher than the level of the filter element. This ensures that a small depth of water is always covering the filter element and the biological layer remains intact.

In the depicted embodiment, the filter system 206 includes twin replaceable biofoam filters 254 that each have a restriction orifice 211 to calibrate the flow rate to allow a biological community to colonize and develop. The replaceable foam filters are light, easy to produce, and easy to ship from a centralized location. The installation process can also be easily performed by inexperienced users. The biological community can form on top of the foam 210 or within the pores of the foam and can create a significant drop in pathogens in the outlet water.

The foam pore density in the current embodiment is about 100 pores per inch. In alternative embodiments, the pore density may be adjusted depending on the application. Polyurethane foam is stable for multiple years and will not be consumed by the microbes. Further, it is available in formulations that pass NSF certification for water contact.

In the current embodiment, each biofoam filter is configured by rolling a sheet of foam 210 into a cylinder and capping it with two end caps 212, 214 to form a radial flow filter element 254. Although the illustrated embodiment includes two biofoam filters, additional or fewer filter elements may be used to scale the system to any size, for example by using filter tees or any other filter connection system. One end cap 214 can be molded with a cylindrical protrusion and grooves for O-rings 216, 218 to seal when the protrusion is inserted into a suitable pipe or fitting. Alternatively, a threaded insert can be used in the molding process of the end cap to provide a threaded member for attaching the filter element to a suitable pipe or fitting.

The filter system 3 can include a support assembly 209, one or more filter elements 254, and one or more filter shields 208. The support assembly 209 can include a shield support 220, a rotatable filter support arm 222, and a rigid pipe 225, 226 connection to the filter container outlet 205. In the embodiment depicted in FIG. 7, the support assembly 209 includes a pair of shield supports 220, a pair of rotatable filter support arms 222, a manifold 225, a pipe 226, a screw connector 228, a nut 230, a face plate 232, a rotation bracket 234, and a filter container outlet 205.

The rotatable filter support arms 222 can be rotated between a filter operating position and a filter maintenance position. Rotating the filter support arm 222 to the filter operation position creates water communication between the filter container and the outlet of the filter container. Rotating the filter support arm 222 to the filter maintenance position prevents water communication between the filter container 200 reservoir and the filter container outlet 205. This prevents unfiltered water in the reservoir of the filter container from entering the clean water stream and causing recontamination. In some embodiments, the filter container can have a minimum water level for operation. In those embodiments, the filter operation position can be configured such that a filter support inlet is below the minimum water level, and the filter maintenance position can be configured such that the filter support inlet is above the minimum water level.

With a filter element in filter operation position, water can travel from the filter container 200 through the foam 210 of the filter element, through the restriction orifice 211 in the end cap 214 of the filter element. The restriction orifice assures, even at the highest elevation of water level in filter 3, the flux through the biological community will not exceed a pre-determined amount, which can benefit the biological community development and pathogen removal. For example, the system can be configured to produce a flux of about 1 ml/min/cm². In alternative constructions, the system can be configured to produce a flux anywhere between 0.5 ml/min/cm² to 5 ml/min/cm². From there, water can flow through the rotatable filter support arm 222 to manifold 225 to pipe 226 and out the filter outlet 205.

The manifold 225 can allow a 90 or other degree turn of the foam cartridge. This provides easy access to the foam cartridge for cleaning, replacement, or other maintenance. This also prevents unfiltered water (water in the filter container reservoir prior to biofiltration) from reaching the filter container outlet and entering the next stage of treatment. The filter support bracket 234 can include a pivot stabilizer 235 that provides additional pivot support that supplements the rotational pivoting of the rotatable support arm 222.

Specifically, after a filtration batch, the water level in the filter container 200 drops to a water level 252 that allows easy access to the foam cartridge. A user can reach into the filter container 200 and rotate the foam cartridge. The fitting between the foam cartridge and the rotatable filter support arm 222 can be a socket fitting. Perhaps as best shown in FIG. 9, the socket can stick out of the water surface 252 when the filter element is rotated. This can prevent unfiltered water in the reservoir of the filter container 200 from entering the clean water stream causing recontamination.

A shield 208 may be provided on the top of the foam cartridges to protect the developed biological community from being disturbed by the splash dripping from the previous container or inlet when water enters the system for treatment. In the current embodiment, the shield is transparent and plastic. In alternative embodiments, the shield can be manufactured from a different material and be opaque or translucent. The shield may attach to the support assembly 209. Specifically, the holes 240 of shield 208 can friction fit over the dimple 221 on the shield support and the hole 240 of shield 208. Further, the shield can be further supported and secured to the shield support by gasket 224.

Perhaps as best shown in FIG. 7, the shield can be generally cylindrical with two cutouts at one end for facilitating rotation of the filter element. The rotatable filter support arm 222 fits through aperture 242 and the filter bracket 234 filter stabilizer connects to a dimple on the shield support 220 through the other aperture 240. The shield can be held in place by way of friction fit with the shield support 220 or by a connector. The shield may be tapered at one end to facilitate ease of rotation of the filter element and the shield. Because the shield is secured to the shield support, which rotates with the rotatable filter arm 222, a user can easily rotate the filter element by rotating the filter element 254 or the shield 208.

The filter support assembly 209 can include a screw connector 228, nut 230, face plate 232, bracket 234, and a filter container outlet 205 that cooperate to provide water communication from the filter element(s) 254 to the filter container outlet 205. The nut 230 and face plate 232 sandwiches the wall of the filter container and are secured in place by screwing the filter container outlet 205 into the screw connector 228. The filter container outlet 205 provides a relatively flush surface with the exterior side wall of the filter container 200 such that the filter container 200 can be nested inside of another container without interference from the filter container outlet 205. The filter container outlet 205 provides an interface for connecting a water treatment system component and creating water communication between the filter container outlet and the component. This connection will be discussed in more detail below.

In the depicted embodiment, water exiting the filter container 200 enters the chlorination system 204.

III. Chlorination

According to at least one embodiment, the gravity feed water treatment system uses a chlorination process to disinfect water by using chlorine to deactivate microorganisms which may reside in the water. Chlorine for water treatment can be obtained from a variety of sources, such as tri-chlorinated isocyanuric acid tablets commonly used in swimming pool applications, calcium hypochlorite, or di-chlorinated isocyanuric acid. Water to be treated is poured into a tank or container, where chlorine is added in measured doses. A filter can later be used to remove the residual chlorine from the water, so that the dispensed treated water does not have a chlorine taste, which may be undesirable to consumers. After water has passed through the chlorination/dechlorination process, it is ready for consumption.

Chlorine tablets made of calcium hypochlorite may be used in some chlorination system embodiments. Such tablets do not typically contain a stabilizer, which some believe to be beneficial. However, without a stabilizer, controlling the dosing of the chlorine can be difficult. Calcium chlorine tablets tend to absorb water when wet and can collapse, which can result in uneven dosing.

The chlorination system 204 of the current embodiment can release a generally consistent chlorine dosage until the tablet is consumed, even for a chlorine tablet without a stabilizer, such as a calcium-based chlorine tablet. The consistent dosage for non-stabilized chlorine tablets can be realized by configuring a chlorination system with one or more of a cone shaped tip in the water stream, a chlorine capsule that shields the tablet from water flow and distributes water evenly around the capsule, horizontal slots on the chlorine capsule, a chlorine tablet trap, and a Teflon screen under the chlorine tablet. The chlorination system of the depicted embodiment provides a chlorine concentration in the water of between 6-10 ppm. In alternative constructions, the chlorine concentration can be increased or decreased.

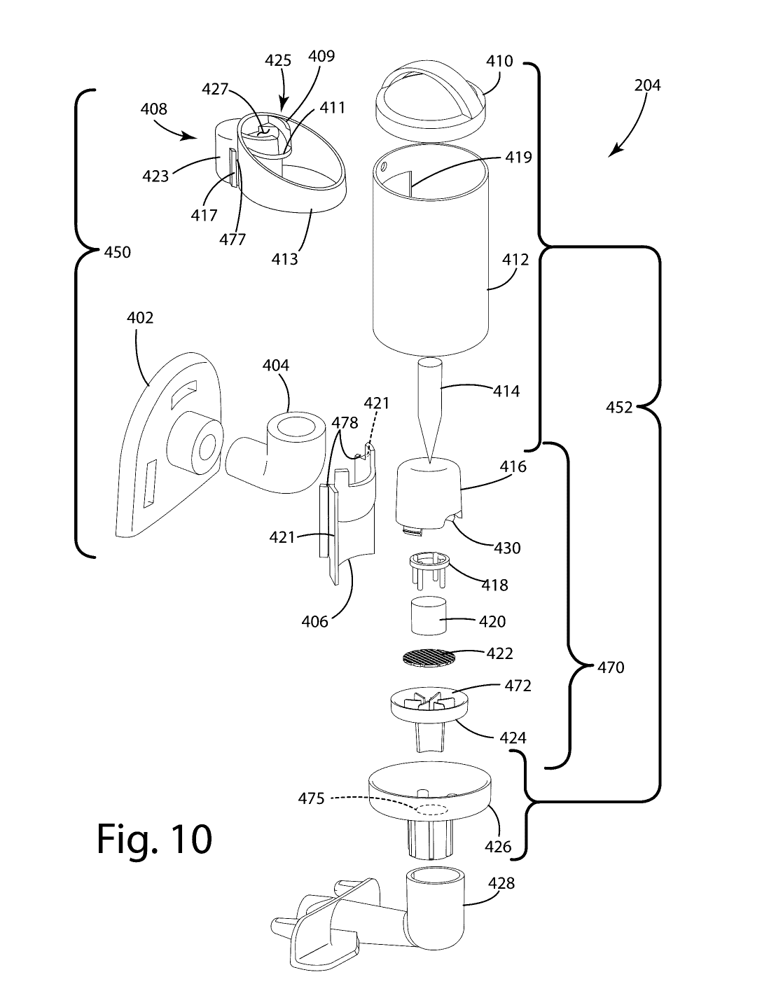

FIG. 10 illustrates an exploded view of a chlorination system 204 according to one embodiment of the present disclosure. The chlorination system generally includes a chlorination inlet assembly 450, a chlorination tank assembly 452, a chlorination capsule 470, and a chlorination outlet 428.

The chlorination inlet assembly 450 includes a chlorination inlet interface 402 for interfacing with the filter container outlet 205, an elbow connector 404, a chlorination system inlet 408, and a support 406. The elbow connector 404 routes water from the chlorination inlet interface 402 to the chlorination system inlet 408.

In the depicted embodiment, the chlorination inlet 408 includes a main body portion 423, a routing portion 425, and a circular support 413. The main body portion 423 is shaped to interfit with support 406 and elbow connector 404. The main body portion 423 includes an aperture 427 for water flow from the chlorination inlet interface 402. The routing portion 425 includes routing walls 409 that retain water flowing from the aperture 427. The routing portion 425 also includes a beveled surface 411 that urges water to fall into the chlorination tank assembly 452. In the current embodiment, the height of the hole 427 is the maximum height in the water flow path from the filter container 200 and accordingly sets the minimum water level height 252 in the filter container 200 and the chlorination inlet assembly 450.

The chlorination inlet main body 423 includes a pair of grooves 477 that interface with edge 419 of an aperture in the chlorination tank assembly to secure the chlorination inlet assembly 450 in place. The grooves 417 are created by the space between protrusion 417 and the circular support 413 on each side of the main body 423. The chlorination inlet 408 includes a circular support 413 that is positioned adjacent the interior surface of the chlorination tank assembly 452 and provides support to secure the chlorination inlet assembly 450. The elbow support 406 also includes a pair of grooves 478 that interface with edge 419 of the aperture in the chlorination tank assembly 452 to further secure the chlorination inlet assembly 450. The extension portions 421 interface with the cover 412 and provide further support when the elbow support is in position.

The chlorination tank assembly 452 includes a cap 410, a cover 412, a cone shaped tip 414, and a base 426. A replaceable chlorine capsule assembly 470 can be placed in the chlorination tank assembly 452. The base 426, cover 412, and cap 410 can be joined together to form a chlorination vessel. The cone shaped tip 414 can be joined with the cap 410 such that the cone shaped tip is positioned within the water flow path. Water exiting the chlorination inlet assembly can drip off of the cone shaped tip onto the top surface of the chlorine capsule assembly 470.

The chlorine capsule assembly 470 includes a chlorine capsule cap 416, a chlorine tablet trap 418, a replaceable chlorine tablet 420, a Teflon screen 422, and a chlorine tablet holder 424. Water falls from the cone shaped tip 414 onto a concave surface of the chlorine capsule cap 416. As the concave surface fills, water spills evenly over the sides of the chlorine capsule cap 416. As water fills up the chlorination base 424, the water enters the chlorination capsule through horizontal slots 430. Eventually, the water level rises and cascades over the sides of the chlorination base 424 where water exits through outlet 475. As the water falls over the side of the base 424, the water level is such that it engages the bottom surface of the Teflon screen 422, which is resting on protrusions 472. In this configuration, the Teflon screen 422 can wick water to the Chlorine tablet 420 thereby controlling the amount of water that reaches the chlorine tablet and the resulting chlorine concentration. The flow rate through the chlorination system is such that the Teflon screen 422 continues to wick water to the bottom of the chlorine tablet. The concentrated chlorine diffuses through the water and eventually water dosed with chlorine exits through outlet 475 of the base 426 to the chlorination outlet 428.

The chlorine tablet holder 424 includes a plurality of raised edges 472 where the Teflon screen 422 sits. The Teflon screen regulates the contact of chlorine with the water. The thickness of the screen can be optimized to 1.4 mm or 0.05 inches, which can ensure the chlorine concentration in the water will be about 6-10 ppm. As water enters the chlorine capsule 470 and comes into contact with the Teflon screen, the water is wicked to the chlorine tablet resulting in some chlorine dissolving into the water solution.

The cover 412 may be secured to the base 426 allowing for a user to access and replace chlorine tablets after they have been consumed by water treatment. In one embodiment, the chlorine capsule cap 416 can be removed and the chlorine tablet 420 can be replaced directly. In another embodiment, the entire chlorine capsule 470 may be replaceable.

A sealed chlorine capsule 470 may be provided that prevents a user from interacting with the chlorine tablet 420 directly. For example, the chlorine capsule cap 416 may be sonic-welded or one-way threaded to the base 424. Optionally, the opening 430 can be removably sealed. Another benefit of the sealed chlorine capsule design is that it facilitates safe handling and compliance with shipping regulations of chlorine tablets. As such, special shipping practices and regulations may come into effect when bulk shipping it. By packaging small quantities in individually sealed capsules, the hazard is greatly reduced and the need for special shipping procedures and regulations is eliminated.

The placement of the cone shaped tip 414 and chlorine capsule 470 enhances the likelihood that untreated water will be fully exposed to the chlorine tablet to receive an appropriate dosage before exiting the vessel via outlet hole 475. It is desirable to design the flow rate through the chlorination system, the flow rate through the wicking material 422, and the rate of diffusion of the chlorine to allow the chlorine to be dissolved into the water at levels which are effective in destroying microbes. If the untreated water is insufficiently exposed, the water within the tank will have too low of a percentage of dissolved chlorine to effectively rid the water of microbes. Conversely, if the water is exposed to too much chlorine, the microbes will be dealt with but the dechlorination filter (if equipped) life will be reduced, and if no filter is used, the high levels of chlorine may result in treated water that has an unsatisfactory taste. For example, the outlet hole 475 may be arranged so as to keep pace with the outlet flow from a flocculation or bio-filter tank. Such a flow rate could be between about 300 and 1500 ml/min. The number and size of the horizontal slots 430 and outlet 475 are designed to achieve a desired chlorine level. The horizontal slots 430 and outlet 475 provide enough flow restriction to allow the water level to rise up and surround the capsule. At the same time, they allow enough water to flow out to keep up with the flow rate of an upstream system.

FIG. 9 shows an assembled chlorinator system or device 204. Because the chlorinator device is attached outside of the bucket instead of floating or being attached inside of the bucket, a user can access the chlorinator device without otherwise disturbing the water treatment system or having to deal with unclean water. Further, portions of the chlorinator device may be see-through allowing a user to see how much of the chlorine tablet is left without opening or accessing the chlorinator device.

Water enters through the inlet flow tube 404 and rises through the hole 427 in the main body portion 423 of the chlorination inlet 408. From there, water drips or falls down over the ledge 411 and is guided by the cone shaped tip 414 to the top surface of the chlorine capsule 416. Water spills over the capsule and a portion of the water flow enters the chlorine capsule through the horizontal slots in the side wall 430 of the chlorine capsule 470. The water entering the slots is regulated by the size and shape of the slots. The slot sizing may be adjusted during manufacture based on chlorine dosing needs. In general, larger slots and more rounded edges will allow more water to flow into the chlorine capsule. In general, smaller slots with sharp edges will allow less water to enter the capsule. The slots regulate the water entering and exiting the chlorine capsule. Water flowing inside the chlorine capsule 470 picks up dissolved chlorine from the chlorine tablet 420. Water eventually flows out through a hole 475 in the base 426. The size of the hole and the amount of air in the chlorination tank assembly 452 regulates the flow rate. Tablet support 424 includes spaced support members 475 that support the chlorine tablet. In this manner, the tablet support controls exposure of the chlorine tablet 420 to the water. Optionally, the chlorine tablet may be located at a height above, below, or aligned with the slots in the side of the chlorine capsule, which would vary the interaction between the water and the chlorine tablet. Further optionally, the position, orientation, and number of slots in the side of the chlorine capsule may be altered to change the interaction between the water and the chlorine tablet. The tablet support also positions the tablet at a height where a user may see the chlorine tablet through a transparent window to determine when to replace the chlorine tablet. Optionally, a portion or all of the chlorine capsule may be transparent to allow viewing of the chlorine tablet.

IV. Safe Water Storage

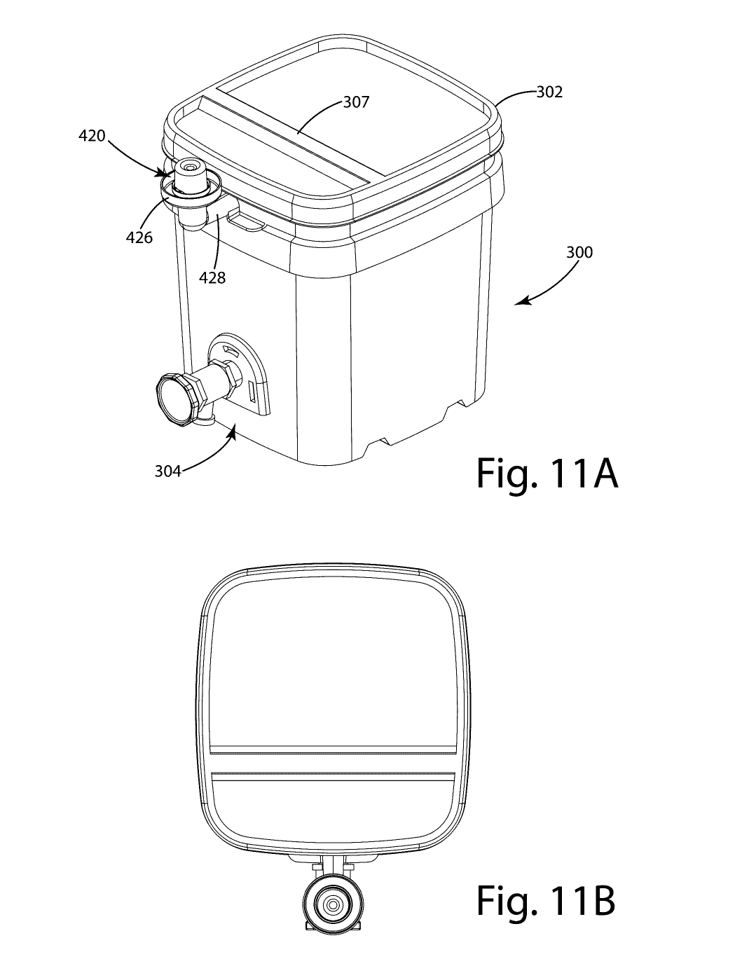

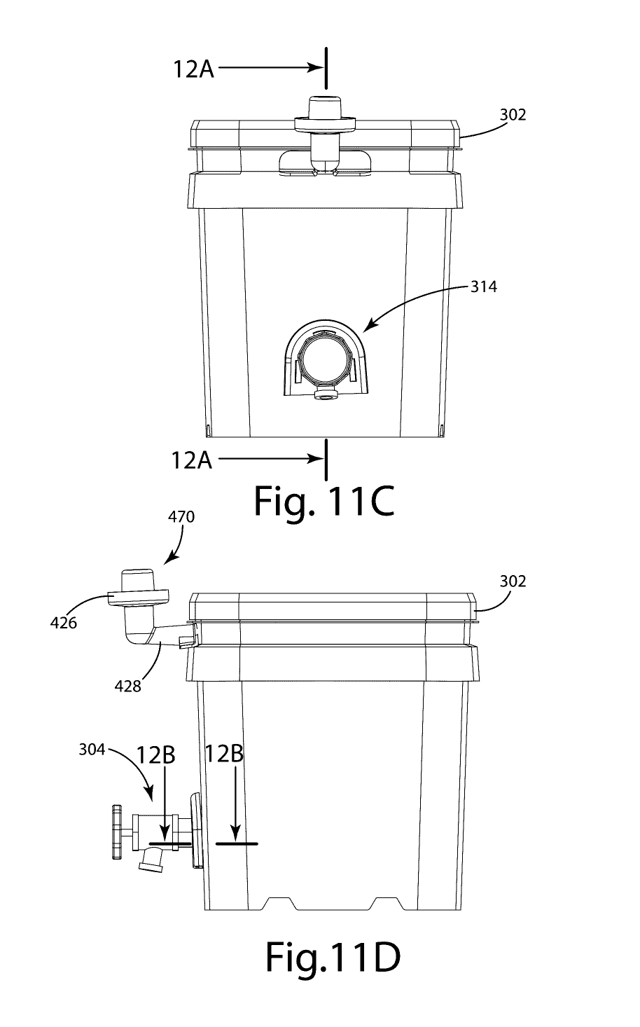

FIGS. 11A-D, 12A-B, 13, and 14 illustrate one embodiment of a safe water storage container 300 of the present disclosure. Water leaving the chlorination system 204 can flow to a4 safe water storage bucket 300 that includes a carbon filter 306 that removes residual chlorine before being dispensed. The residual chlorine can remain in the water while it sits in the safe water storage bucket and prevent secondary contamination.

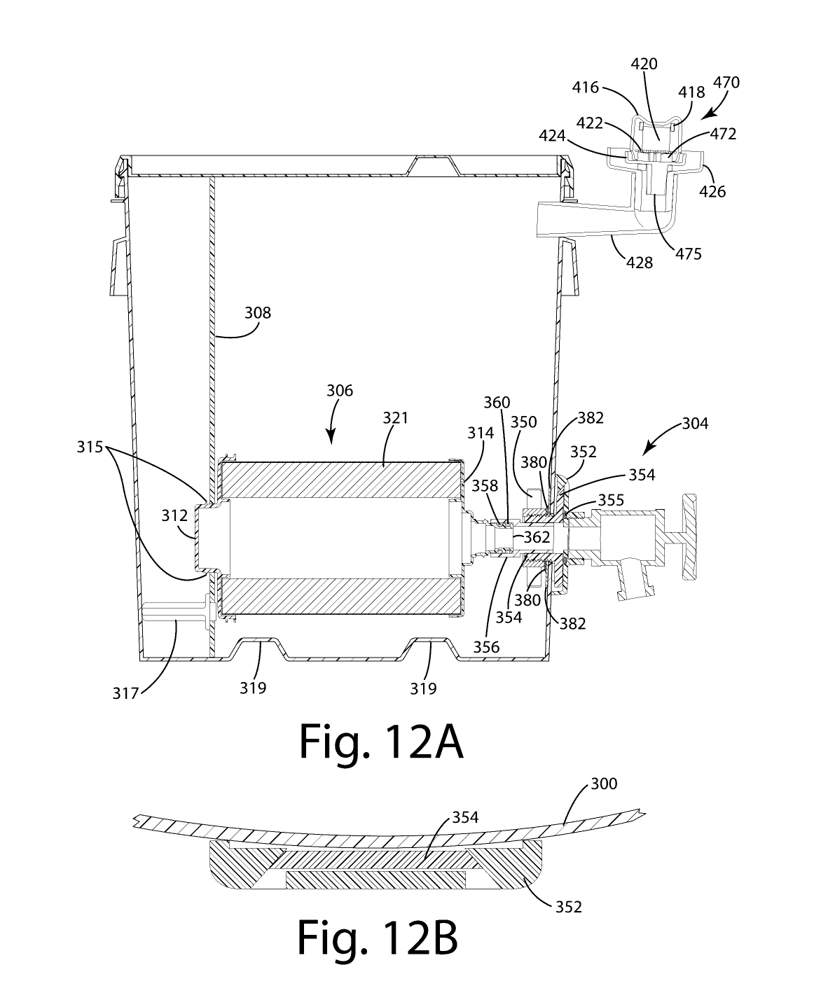

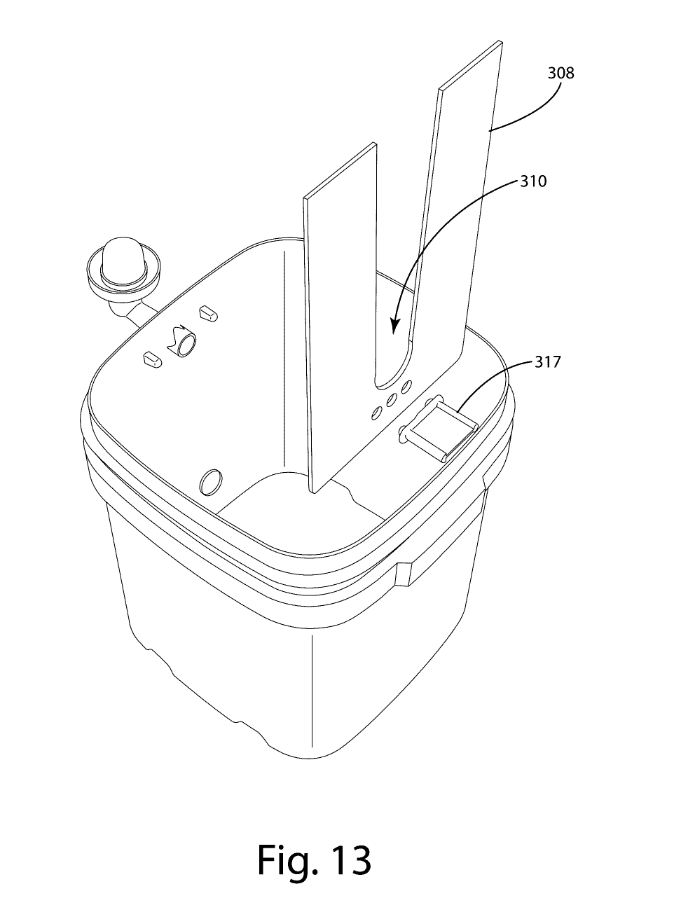

The safe water storage container can include a frame 308 that prevents the carbon block from floating to the surface of the water in the safe water storage container. Perhaps as best shown in the exploded view of FIG. 13, the bottom of the frame 308 includes a U shaped opening 310 that can clamp on the endcap of a carbon filter. The frame 308 can include a spacer 317 that spaces the frame away from the side wall of the safe water storage container. Further, perhaps as best shown in FIG. 12A, the top of the frame 308 touches the lid, which fixes the horizontal location of the carbon block.

Also residing in the tank 300 is a carbon filter 306 for removing the chlorine dissolved in the water present in the tank. A bushing 356 can connect the filter to a spigot or valve 304 and can be sealably connected to the filter and spigot by O-rings 358, 360. The filter 306 can include two end caps 312, 314 and a filter material 321.

The end caps 312, 314 can be separately manufactured, for example, by conventional injection molding, and then attached to the carbon filter material by cement, adhesive or otherwise. If desired, a threaded insert can be used in the molding process of one of the end caps 314 to provide a threaded member for attaching the carbon filter 306 to a suitable pipe or fitting. Alternatively, the end cap 314 can be molded with a cylindrical protrusion and grooves for O-rings to seal when the protrusion is inserted into a suitable pipe or fitting. The other end cap 312 may be manufactured with retaining features 315 to help hold the carbon block in place on frame 308.

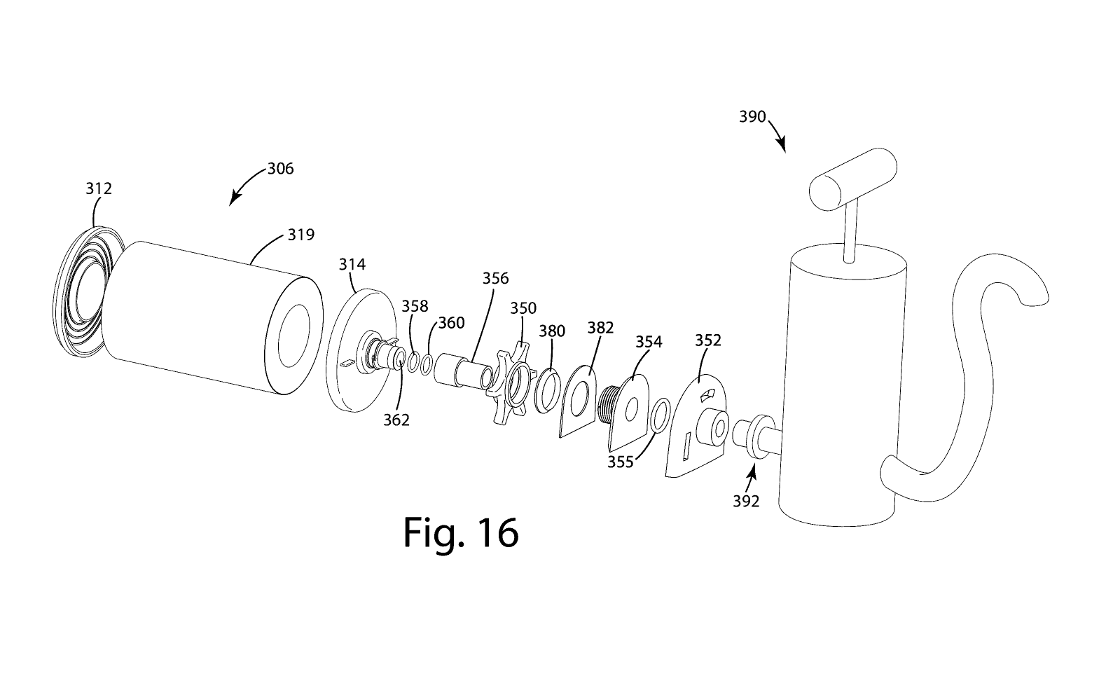

Perhaps as best shown in FIG. 16, the filter 306 can connect to the safe water storage outlet 354 by way of a similar configuration as shown in the filter container. The safe water storage container includes a connector assembly for connecting a filter to the outlet. The connector assembly includes a screw connector 350, nut 380, face plate 382, and safe water storage outlet 354 that cooperate to provide water communication from the filter element 306 to the safe water storage outlet 354. The nut 380 and face plate 382 sandwiches the wall of the filter container 300 and are secured in place by screwing the filter container outlet 205 into the screw connector 350. The filter container outlet 354 provides a relatively flush surface with the exterior side wall of the container 300 such that the container 300 can be nested inside of another container without interference from the container outlet 354. The safe storage container outlet 354 provides an interface for connecting a water treatment system component and creating water communication between the outlet 354 and the component.

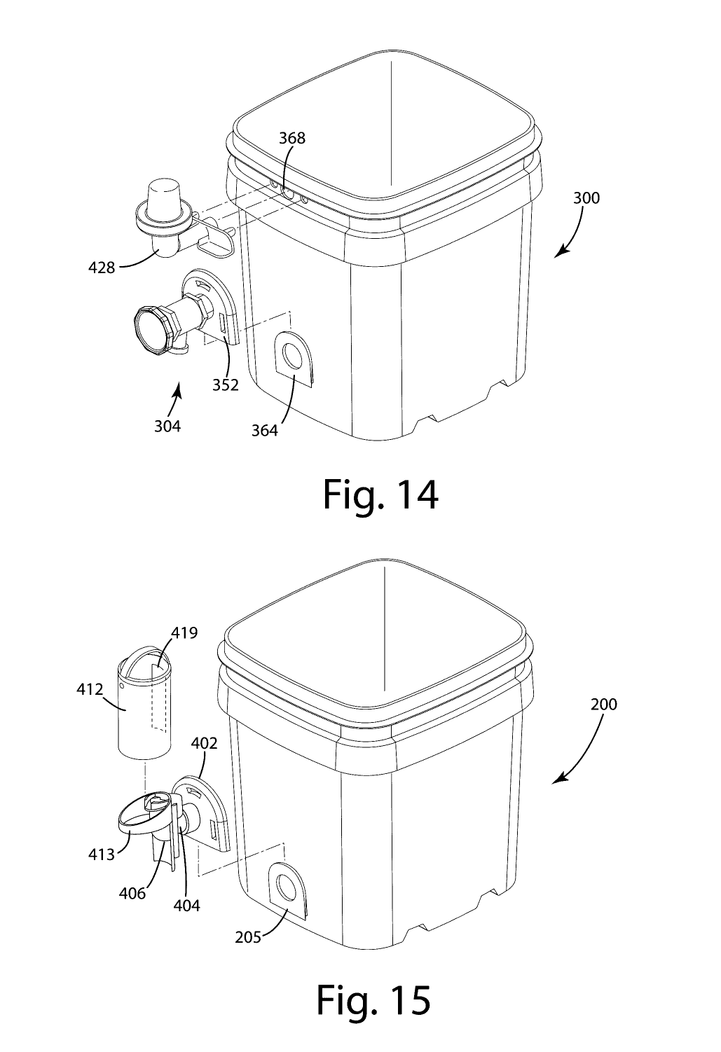

A spigot can be connected to the outlet 354 by way of a connector 352, as shown in FIGS. 11A-D and FIG. 14. Referring to FIG. 14, the outlet 364 is shaped to receive connector 352 and create a sealed water flow communication path.

In the depicted embodiment, water flows through the system using gravity alone. If faster removal of water from the safe water storage container is desired, a manual pump can be used to increase flow rate through the carbon filter and the outlet.

Some gravity feed water treatment systems are large, heavy, and relatively immobile. Many gravity feed water treatment systems are forced to make trade-offs between flow rate and performance. That is, in order to have a higher flow rate, filtration performance sometimes is sacrificed, or vice versa. A system that operates without pressurized plumbing and without electric power, but offers purification of water approaching the filtration and flow rate performance of a system using pressurized plumbing and electric power is desirable.

In one embodiment, a water treatment system with a pump for assisting water flow provides disinfection, filtration, chemical adsorption, and high flow rates without pressurized plumbing or electric power. A manual pump 390 is illustrated in FIG. 16. A user can draw water from the water system using the manually activated piston pump installed on the outlet of the system.

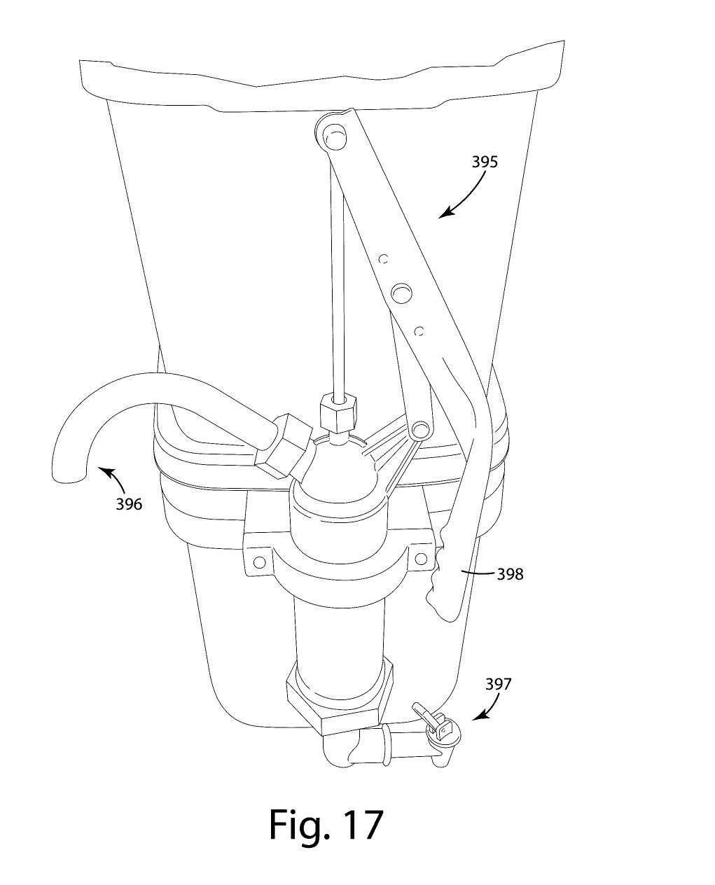

In alternative embodiments, different kinds of pumps can be used to activate the water flow. For example, FIG. 17 illustrates a hybrid pump 395 that allows for manual pump activation using handle 398 through outlet 396. Alternatively, spigot 397 can be opened to allow water flow by gravity.

When water is drawn from the tank for consumption, it first passes through a press block of activated carbon 306. Optionally, a pleated filter media may be installed over the carbon block to filter large particles and prevent clogging of the carbon block. In some circumstances the water head pressure in a small residential-sized tank (about 5 gallons) is not sufficient to cause the water to flow through the filter block. Therefore, a manually operated piston pump may be installed. When the piston pump handle 395 is lifted, the piston (not shown) inside the body of the pump 395 creates a negative pressure differential compared to the water pressure on the inlet side of the filter block. This causes water to flow through the filter block, into the filter outlet 354, and up into the body of the pump 395. As the water is drawn up through the body of the pump it can pass through a one-way rubber flapper valve. Also, as new water is drawn into the body it can displace water already present therein. The displaced water can escape through the water spout 396 at the top of the pump. The diameter and stroke length of the piston are the variables for the system designer or system installer to adjust to achieve the desired water flow delivery per stroke. For example, given a stroke duration of 2 seconds and a piston volume of 126 ml, a net flow rate of 3780 m (about one gallon) 1 per minute may be achieved.

V. Removable Water Treatment System Components

FIGS. 14 and 15 illustrate how various exemplary water treatment system components are selectively removable from the system. These components can be mounted in place to configure the nest and stack containers as a water treatment system. The components can also be removed from the nest and stack containers so that the containers can be stacked inside of one another into a portable configuration. The outlet connectors 364, 205 provide a connection for the connectors 352 and 402 to make sealable water connections, while also providing a generally flush surface that does not interfere with nesting of the nest and stack containers 100, 200, 300. Other components merely connect by way of friction fit, such as the chlorination outlet 428, which friction fits into holes 368 of container 300.

In one embodiment the outlet connectors 364, 205 and any other connectors on the system can be configured as modified French cleats. That is, the outlet connectors can provide a molding with a 30-45 degree slope that allows a matching edge cut into a connector to hang or slide over the molding. Retaining features may be provided at different portions around the perimeter of the connector that further stabilize and secure the connector by interfacing with the outlet connector. That is, the retaining feature can act as a groove that the side of the outlet connectors slides into. The sectional views of FIGS. 12A-B illustrate one embodiment of a connector 352 joined with an outlet connector 364. In this embodiment, safe water storage outlet 354 forms an outlet connector 364 for connector 352 to interface.

VI. Two Container Water Treatment System

Several alternative embodiments of a water treatment system and various alternative embodiments for components of the water treatment system are illustrated in FIGS. 18-35. For example, FIG. 18 illustrates an alternative water treatment system embodiment that includes two nest and stack containers with water treatment system components that cooperate as a water treatment system 900. As with the three container embodiment, the water treatment system 900 can be selectively configured between a transportation configuration and a water treatment system configuration. Perhaps as best shown in the perspective view of FIG. 18, the depicted embodiment of the water treatment system includes a first container 1000, a second container 2000, and a spigot 3004.

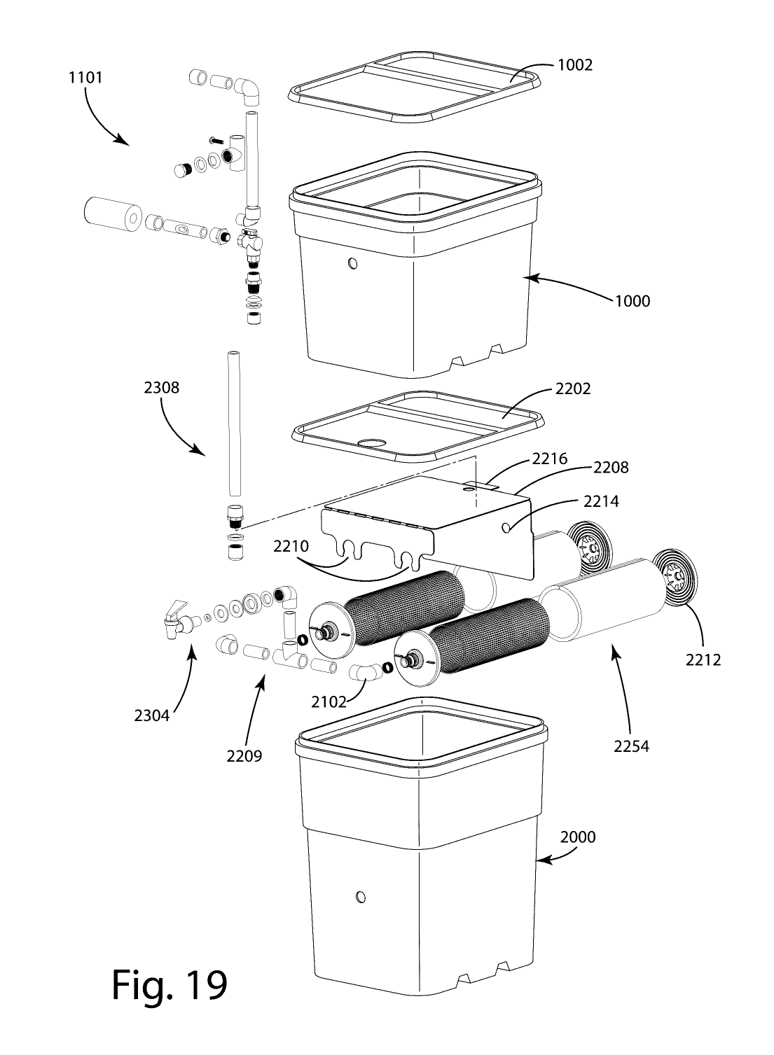

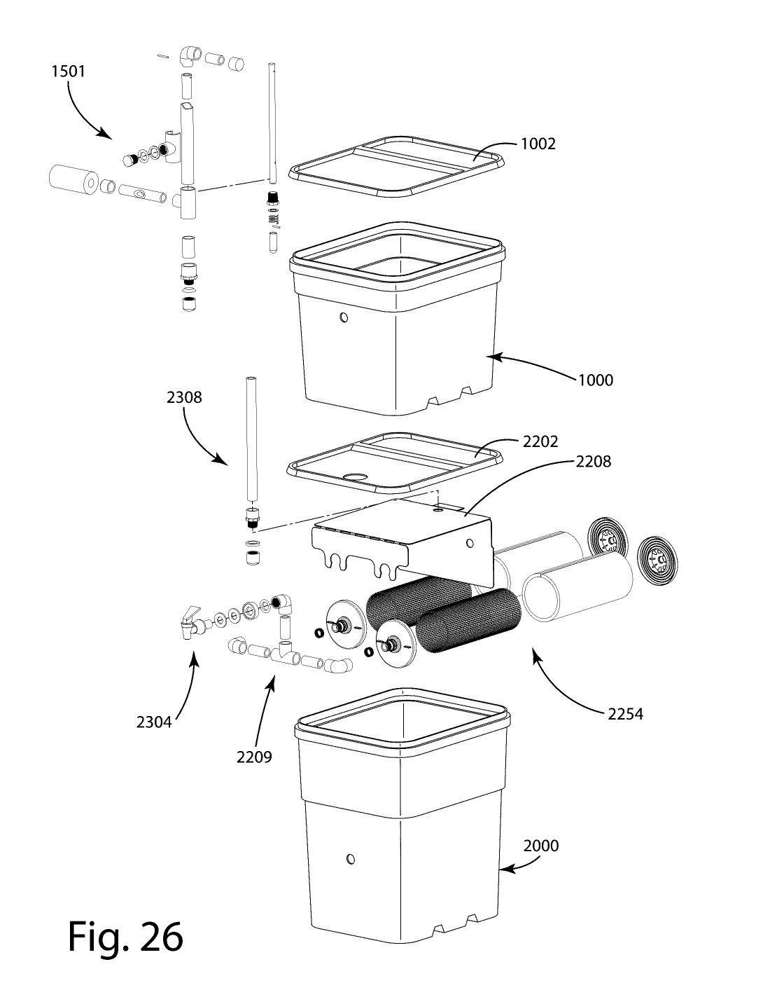

The water treatment systems of the present invention can be configured with a variety of different components to provide a variety of different alternative embodiments. For example, the water treatment system 900 can include a number of different manual valve assemblies for releasing water from the first container to the second container. FIGS. 19-25 illustrate an alternative embodiment manual valve assembly that utilizes a ball valve. FIGS. 26-34 illustrate an alternative embodiment manual valve assembly that utilizes a ramp, spring, and ethylene propylene diene monomer rubber (EPDM) plug. In addition, FIGS. 19 and 26 illustrate an alternative embodiment filter shield and vertical support and FIG. 35 illustrates an alternative filter embodiment that includes a carbon sleeve around a bio-foam filter. Although these alternative water treatment system components described in connection with a two container water treatment, it should be understood that the various components can be utilized with other alternative embodiments. For example, the alternative shield, alternative vertical support, and alternative manual valve assemblies can be implemented in the previously described three container embodiment.

The two container water treatment system 900 can be configured as a two stage water treatment system (flocculation and bio-filtration) or a four stage water treatment system (flocculation, chlorination, carbon filtration, and bio-filtration). The flocculation stage and chlorination stage, if present, can take place in the first, flocculation/chlorination, container 1000, while the carbon filtration stage, if present, and the bio-filtration stage can occur in the second, carbon/bio-filtration, container 2000. In this embodiment, the carbon/bio-filtration container 2000 also can act as a safe water storage tank. Just as with the three container embodiment, each of the nest and stack containers may have an associated lid 1002, 2202 to accommodate stacking and water flow between the containers.

The four stage two container water treatment system embodiment has a modified sequence of treatment of water relative to the four stage three container water treatment system embodiment described above. Specifically, instead of a chlorination step after bio-foam filtration, chlorination is conducted contemporaneously with flocculation. Further, the water path subsequent to flocculation and chlorination is directed through a carbon block, which removes chlorine from the water, before the water path is directed through a bio-foam filter. In short, this alternative configuration provides a treatment sequence of flocculation and chlorination to carbon filtration to bio-foam filtration. This treatment sequence can be accomplished with two containers: a flocculation/chlorination container 1000 and a carbon/bio-foam filtration container 2000, which can reduce the cost and footprint of the water treatment system.

The flocculation stage can be carried out using essentially any flocculation method. For example, flocculation can be conducted in the flocculation/chlorination container 1000 using one or more flocculants. Untreated water can be mixed with the flocculant(s), sometimes referred to as coagulant(s), and allowed to settle for a period of time. Further, a method of accelerating flocculation can be implemented in this two container water treatment system—where two flocculants are utilized with a pre-determined delay period in-between introduction to the water.

Before water is released to the second container 2000, the water can be disinfected. In one embodiment, a chlorine source, such as a powder form of calcium hypochlorite can be added to the water. In alternative embodiments, a different chlorine source or other disinfectant can be utilized to provide a desired disinfectant dosage to the water. The chlorine can be added before, simultaneously, or shortly after the flocculant is added to the water. In some embodiments, chlorine powder is added to the water sufficient to provide a chlorine concentration of around 6-8 ppm. The targeted contact time for the chlorination process is about 30 to 60 minutes.

The combination of chlorination and flocculation enables a desired amount of arsenic removal from the water. The chlorine converts As(III) to As(V), which can occur instantaneously. The flocculation process effectively removes a substantial amount of As(V). Specifically, some embodiments can remove upwards of 97% or more of As(V) during the flocculation stage. Once flocculation is complete, a manual valve assembly may be used to release the water to the carbon/bio-foam filtration container 2000 for carbon and bio-filtration water treatment stages.

It should be understood that components such as pipes, caps, elbows and other components can be manufactured from polyvinyl chloride (PVC) or other suitable materials.

FIGS. 19-25 illustrate one alternative embodiment of a manual valve assembly 1101 that includes a ball valve 1114. The assembly 1101 includes a handle 1109. In the illustrated embodiment the handle is a cap 1300, pipe 1302, and elbow 1304 press fit together.

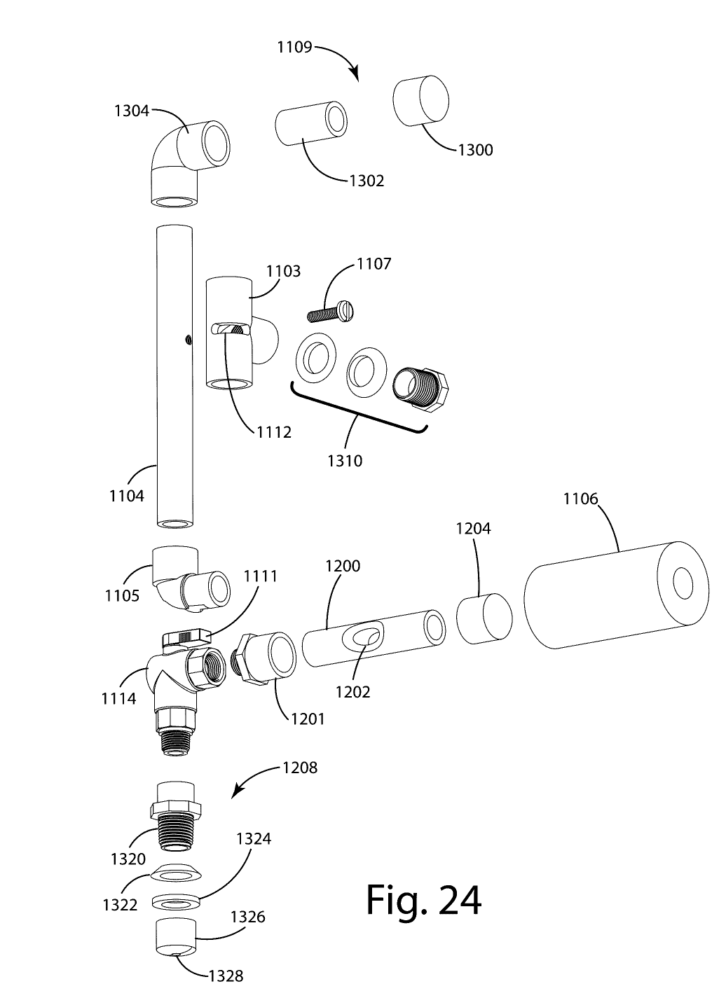

The handle 1109 can be attached to a member 1104 that travels through a tee fitting 1103 secured to the container 1000 by way of a plug assembly 1310. This tee fitting 1103 is bored out to allow free rotational movement of the member 1104. Perhaps as best shown in FIG. 24, a screw 1107 passes through a pocket or slot 1112 in the tee fitting and through an aperture 1108 in the member. The screw 1107 and slot 1112 in the tee fitting 1103 cooperate to restrict rotational freedom of the member 1104 to about 90 degrees.

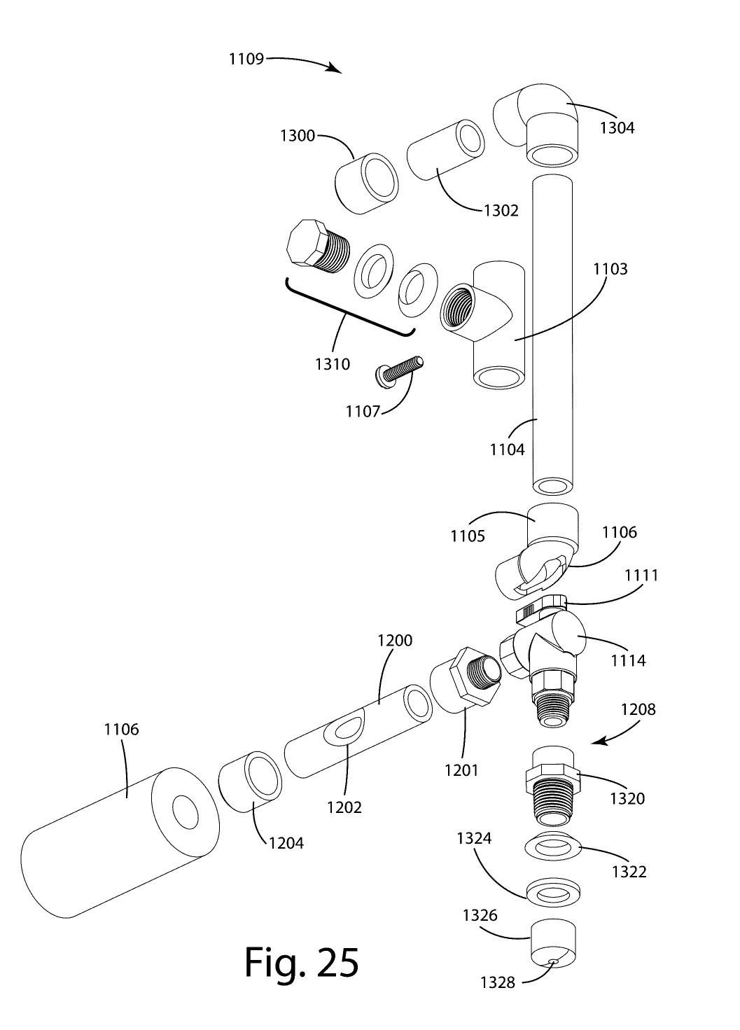

At the end of the member 1104 an elbow fitting 1105 is joined to the member. Perhaps as best shown in the FIG. 25 exploded view, the elbow 1105 is pocketed with a hole 1106 the same shape as the ball valve handle 1111. The pocketed fitting 1105 can capture the ball valve handle 1111 such that rotation of the handle 1109 results in rotation of the ball valve handle 1111, which open and closes the ball valve 1114. In the depicted embodiment, the nylon screw 1107 travels in the groove 1112 of the tee fitting 1103 to help ensure that the ball valve handle 1111 is not over torqued.

Connected to the ball valve is a pipe 1200 with scallop cuts 1202 made on the sides and a cap 1204. A foam filter 1106 is placed over the scalloped cut pipe 1200 to prevent or reduced flocked contaminates from navigating further through the system. Once the ball valve is opened the water flows from the reservoir of the flocculation container through the filter 1106 into the scalloped cut pipe 1200, then through the male adapter 1201 to the ball valve 1114 and through the fittings 1208 to exit the first container. In the depicted embodiment, the fittings 1208 include a male adapter 1320, a gasket 1322, a washer 1324, and a cap 1326. A hole 1328 can be drilled or otherwise provided in the cap 1326 at a specific diameter to control the water flow rate.

FIGS. 26-34 illustrate another alternative embodiment of a manual valve assembly 1501 that includes a ramp, spring, and EPDM plug. The assembly 1501 includes a handle 1509. In the illustrated embodiment the handle is a cap 1300, pipe 1302, and elbow 1504 press fit together. The handle 1509 is attached to a pipe 1505 that snaps into a saddle fitting 1503. This saddle fitting 1503 keeps the pipe 1505 stationary. The saddle fitting 1503 is secured to the side of the container 1000 with gaskets and fittings 1510 that screw through the container wall 1000.

The handle 1509 and pipe 1505 each have a detail that creates respective ramps 1508, 1510. A ½″ rod 1512 has two holes 1514, 1516 bored at different heights. The rod 1512 is positioned through the threaded fitting 1518, washer 1520, spring 1522 and the EPDM rubber plug 1524 is installed at one end of the rod 1512. The rod 1512, pipe 1511 and elbow 1504 are coupled by way of pin 1700. Pin 1700 is inserted through the hole 1515 in elbow 1504, through hole 1516 in pipe 1511, and through hole 1514 in rod 1512 such that vertical movement of the elbow 1504 results in vertical movement of pipe 1511 and rod 1512 because of the coupling by way of pint 1700. Pin 1702 is inserted in hole 1516 in rod 1512 such that vertical movement of the rod 1512 compresses the spring 1522 by way of interaction with pin 1702.

The rod 1512 travels inside pipe 1508. The fittings 1520, 1522 and 1524 travel below fitting 1518. The washer 1520 provides friction relief between spring 1522 and threaded fitting 1518. The pipe 1508 can be threaded internally to accept a threaded fitting 1518 securing the ½″ rod 1512 from traveling out of the assembly. The EPDM rubber stopper 1524 that is around the rod 1512 is spring loaded in a closed position, touching off on the male adapter 1526, until the handle 1509 is rotated. Rotating the handle 1509 causes the respective ramps 1508, 1510 of the pipe 1505 and elbow 1504 to interface and move the rod 1512 along with the EPDM plug 1524 vertically, thereby compressing the spring 1522. This vertical movement causes the stopper 1524 to disengage from the male adapter 1526, creating a bypass for water to travel. When the handle is rotated in the opposite direction the rubber stopper 1524 re-engages with the male adapter 1526 and stops the flow of water. The closed valve position is depicted in FIGS. 28-30 and the open valve position is depicted in FIGS. 31-33.

The tee 1528 is press fit into the threaded pipe 1505 and pipe 1506. Connected to the tee 1528 is a pipe 1600 with scallop cuts 1602 made on the sides. This pipe 1600 can be capped with a cap 1604. A foam filter 1106 can be placed over the scalloped cut pipe 1600 to prevent flocked contaminates from moving further through the system. Once the handle 1509 is rotated the water flows through the scallops passed the tee 1528 and through the fittings exiting the container. The final fittings before exiting the container include a gasket 1530 and a cap 1532 with a hole 1534 drilled to a specific diameter to provide a specific flow volume or flow rate to the second container 2000.

In both the FIG. 19 and FIG. 26 embodiments, the water flows down into the next container 2000 by way of gravity. In the depicted embodiment, the second container 2000 has two foam filters 2254. The foam filters are shielded by a sheet of plastic (polypropylene) that has been shaped into a shield 2208, perhaps as best depicted in FIGS. 19 and 26. This sheet can be laser cut, water jet cut, cnc routered or shaped via another method. This plastic sheet can be bent in two locations that create a “C” shape. The features of this shield 2208 include snap details 2210 that attach around the elbows 2102 that the filters 2254 are attached to, this shield 2208 also has two holes 2214 that capture the filter end caps 2212 creating a fixed rear location for the filters (keeping them from touching and disturbing the bio layer), the shield 2208 has a tab 2216 that extends towards the rear keeping the filters from backing out of their attachments and creating a bypass path. The shield 2208 also has a vertical support 2308 that is made from a cap 2310, a male adapter 2312 and a long pipe 2314. The cap can have a hole in its bottom to keep water that may have entered in the support pipe stagnant.

When the dispenser is operated, water flows from the reservoir of the second container through the foam filters 2254, through the fittings 2209, and out the dispenser assembly 2304. A flow restrictor can be placed in the dispenser assembly or elsewhere in the water path to ensure a specific flow rate through the foam filters and to increase filter performance. For shipping, the dispenser can be uninstalled, and the two container system can be nested and stacked inside of each other.

In the alternative embodiment two container water treatment systems depicted in FIGS. 19 and 26, the second container houses a filtration system that connects to a spigot for dispensing water. The depicted filter systems are different from the filter system described in connection with the three container water treatment system—the filters in FIGS. 19 and 26 are not rotateable between a filter operating position and a filter maintenance position. However, the depicted systems could be modified to incorporate that, or other, features from the two container water treatment system described previously (or vice versa).

Although foam filters are depicted in 19 and 26, different replaceable filters can be utilized instead. For example, if a disinfectant, such as chlorine powder, is added during the flocculation process, the filtration system can include a two part filter—one portion of the filter includes a filter material, such as carbon, for chlorine removal and a second portion of the filter includes a different filter material, such as bio-foam, for bio-filtration. By sequencing the treatment differently and utilizing a two-part filter, chlorine can be removed before the water reaches the bio-foam, which could reduce the effectiveness of the bio-foam filtration. In addition, this combination filter allows for the safe water storage tank can be eliminated, which can reduce the cost and footprint of the water treatment system.

One example of a two part filter is a carbon sleeve that surrounds a foam filter. A sectional view of one example of such an embodiment of a two part filter is shown in FIG. 35. As shown, a carbon sleeve 3000 is provided around the foam filter 3002 and support core 3004. In some embodiments, the foam filter 3002 and support core 3004 are essentially identical to foam filters 254, 2254—that is, they have essentially the same dimensions and properties as the foam filters 254, 2254. The main difference is that a carbon sleeve surrounds the foam to filter out chlorine before it reaches the foam and potentially destroys or disrupts the biological organisms present in and/or on the foam material. In one embodiment, the carbon sleeve is a half inch thick and made from 20×60 mesh powdered activated carbon. In the depicted embodiment, the inner diameter of the carbon sleeve is about the same as the outer diameter of the foam filter.

The depicted embodiment utilizes a radial flow filter, though other embodiments could implement a different type of filter. Water flows radially through the outside carbon sleeve 3000 and then radially through the foam filter material 3002 into the support core 3004. In one embodiment, the carbon sleeve acts to remove the residual chlorine left from the chlorine that was added during the flocculation process. A half inch carbon sleeve can be effective at removing residual chlorine for more than 10 years based on an assumption that the system treats about 7 gallons of water or one batch a day. The amount of carbon can be varied to change the effective life of the carbon sleeve depending on a variety of variables. The properties of the carbon sleeve can be selected so that chlorine will not reach the surface of the foam layer under the carbon sleeve. This enables the microbial community to still develop on and/or in the foam and serve as an additional barrier for pathogenic organisms. In the depicted embodiment, the flow rate of water through the filtration system is regulated at the dispenser instead of by the exit of the filter cartridge.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A water treatment system comprising:
a flocculation container having a flocculation container inlet for receiving water and a flocculation container outlet for dispensing water, said flocculation container having a bottom surface where floc settles after flocculation;
a filter mounted in said flocculation container for filtering floc and particles out of the water, said filter having a filter inlet and a filter outlet;
a manual valve assembly that includes a valve that selectively controls flow of water through said flocculation container, wherein said valve is manually movable between an open valve position and a closed valve position, wherein said filter outlet and said valve are in fluid communication in said open valve position to create a water flow path through said valve to said flocculation container outlet, wherein said filter outlet and said valve are not in fluid communication in said closed valve position to hinder a water flow path through said manual valve assembly to said flocculation container outlet;
wherein said water treatment system includes a flow restriction aperture for restricting the flow rate of water through said flocculation container outlet.

2. The water treatment system of claim 1 wherein said flocculation container outlet defines said flow restriction aperture that restricts the flow of water to a flow rate of at most 1 L/min.

3. The water treatment system of claim 1 wherein the position of said filter inlet within the flocculation container is selected based on an anticipated maximum amount of sediment for a full container of water with a predetermined amount of flocculant.

4. The water treatment system of claim 1 wherein the position of said filter inlet within the flocculation container is selected based on an anticipated number of flocculation batches between cleaning cycles including accumulated sediment removal.

5. The water treatment system of claim 3 wherein a flocculation status visual indicator is positioned adjacent said filter inlet, visibility of said flocculation status visual indicator by a user viewing the interior of said flocculation container is hindered by floc during flocculation and said flocculation status visual indicator is visible by a user viewing said flocculation container once flocculation is substantially complete and floc has settled on said bottom surface of said flocculation container below said filter inlet.

6. The water treatment system of claim 1 wherein said manual valve assembly includes a vertically movable member that cooperates with a filter support, wherein a gasket surrounds said vertically movable member and is positioned adjacent an aperture in said filter support such that in said open valve position said aperture and a flow restriction aperture in said filter support are aligned and such that in said closed valve position said gasket seals a water flow path between an exterior surface of said vertically movable member and an interior surface of said filter support.

7. The water treatment system of claim 1 wherein said manual valve assembly includes a rotatable shaft, wherein said shaft is rotatable to change said valve between said open valve position and said closed valve position.

8. The water treatment system of claim 1 wherein said flocculation container outlet has about a 0.161 inch diameter.

9. The water treatment system of claim 1 wherein said valve is a ball valve assembly.

10. The water treatment system of claim 1 wherein said valve includes a moveable rod having an EPDM plug, wherein the moveable rod is moveable between a first position where the EPDM plug interfaces with a surface to seal a water path through said outlet and a second position where the EPDM plug disengages the surface to create a water path through said flocculation container outlet.

11. A water treatment system comprising:
a container having a container inlet for receiving water into said container and a container outlet for dispensing water out of said container;
a filter support assembly mounted to said container in water communication with said container outlet, said filter support assembly including a filter support configured to receive a replaceable filter and a shield for preventing disturbance of said replaceable filter by water from said container inlet.

12. The water treatment system of claim 11 wherein said filter support and said shield are rotatable between a filter operation position and a filter maintenance position.

13. The water treatment system of claim 11 wherein said shield is substantially C-shaped and includes snap details, mounting holes, and a tab for mounting said shield within said container and to said filter support.

14. The water treatment system of claim 11 wherein said filter support assembly includes a shield support and said shield is joined to said shield support.

15. A flocculation process comprising:
adding a first flocculant to a flocculation chamber having water;
mixing the first flocculant and water in the flocculation chamber;
waiting a pre-determined delay period for flocs to begin to form;
adding a second flocculant after the pre-determined delay period to accelerate floc formation;
mixing the water, first flocculant, and second flocculant in the flocculation chamber; and
waiting for the flocs to sufficiently settle to the bottom of the flocculation chamber.

16. The flocculation process of claim 15 wherein mixing the first flocculant and water in the flocculation chamber including mixing for about one minute.

17. The flocculation process of claim 15 wherein the pre-determined delay period is at least fifteen seconds.

18. The flocculation process of claim 15 wherein the pre-determined delay period is between 15 second and five minutes.

19. The flocculation process of claim 15 wherein mixing the first flocculant, second flocculant, and water in the flocculation chamber including mixing for about one minute.

20. The flocculation process of claim 15 wherein waiting for the flocs to sufficiently settle to the bottom of the flocculation chamber includes waiting between ten minutes and two hours.
